(19) United States
(12) Patent Application Publication
(10) Pub. No.: US 2026/0333436 A1
(43) Pub. Date: Oct. 22, 2026

(54) METHOD AND DEVICE FOR ALLOCATING SHARED PORTION OF TRANSMISSION-OPPORTUNITY (TXOP) WITHIN COORDINATED-TIME-DIVISION-MULTIPLE-ACCESS (CO-TDMA) SCHEME

(71) Applicant: Samsung Electronics Co., Ltd., Suwon-si (KR)

(72) Inventors: Abhishek CHATURVEDI, Bangalore (IN); Ankur BANSAL, Bangalore (IN); Karthik Srinivasa GOPALAN, Bangalore (IN)

(21) Appl. No.: 19/656,182

(22) Filed: Apr. 23, 2026

Related U.S. Application Data
(63) Continuation of application No. PCT/KR2026/005376, filed on Apr. 15, 2026.

(30) Foreign Application Priority Data
Apr. 15, 2025 (IN) 202541036436
Mar. 25, 2026 (IN) 2025 41036436

(51) Int. Cl. H04W 74/0816; H04W 8/00; H04W 48/20; H04W 74/06

(52) U.S. Cl. CPC H04W 74/0816; H04W 8/005; H04W 48/20; H04W 74/06

(57) ABSTRACT

A method performed by a device for allocating a shared portion of transmission opportunity (TXOP) within a coordinated time division multiple access (Co-TDMA) scheme is provided. The method includes identifying, by the device, a set of parameters associated with dynamic data traffic characteristics and channel access characteristics, generating, by the device, allocation rules based on these parameters, transmitting, by the device, to multiple neighboring access points (APs) participating in the Co-TDMA scheme, initiating, by the device, a negotiation of the allocation rules with at least one neighboring AP of the plurality of neighboring APs participating in the Co-TDMA scheme to determine candidate APs, and determining, by the device, one AP from the one or more candidate APs for allocating the TXOP, based on a predefined AP selection procedure associated with the dynamic traffic characteristic parameters and channel access characteristic parameters.

### CROSS-REFERENCE TO RELATED APPLICATION(S)

This application is a continuation application, claiming priority under 35 U.S.C. §365(c), of an International application No. PCT/KR2026/005376, filed on Apr. 15, 2026, which is based on and claims the benefit of an Indian Provisional patent application number 202541036436, filed on Apr. 15, 2025, in the Indian Patent Office, and of an Indian Non-Provisional patent application number 202541036436, filed on Mar. 25, 2026, in the Indian Patent Office, the disclosure of each of which is incorporated by reference herein in its entirety.

### TECHNICAL FIELD

The disclosure relates to the technical field of wireless communications, specifically focusing on multi-Access Point (AP) coordination schemes such as Coordinated Time Division Multiple Access (Co-TDMA). More particularly, the disclosure relates to methods and systems for allocating shared portion of Transmission Opportunity (TXOP) within a Coordinated Time Division Multiple Access (Co-TDMA) scheme.

### BACKGROUND

The ongoing development of the wireless-fidelity (Wi-Fi) 8 standards aims to optimize channel resource utilization among neighboring Access Points (APs), thereby enhancing overall traffic management and user experience regarding latency, reliability, and throughput.

Existing techniques provide procedures for APs to share portions of their Transmission Opportunities (TXOPs) through protocols that involve capability advertisement, negotiation, and resource sharing phases. However, these approaches often falter in ensuring fair access to shared resources. A significant limitation of current solutions is their reliance on inadequate and singular criteria for determining APs eligible to utilize shared TXOP segments, thereby compromising the fairness aspect critical to the Co-TDMA scheme.

For instance, existing methods may overlook key characteristics such as traffic priority, latency requirements, and overall channel access needs, resulting in scenarios where less deserving APs gain access at the expense of higher-priority ones. Moreover, these systems lack flexibility to adapt to the dynamic nature of traffic characteristics and do not facilitate re-negotiation of parameters once agreements are reached, leading to airtime and signaling inefficiencies. Accordingly, there exists a need in the art for an improved method and system that addresses these shortcomings in fairness and efficiency within Co-TDMA schemes, ensuring that APs which genuinely fulfil the fairness criteria are granted appropriate access to share TXOPs.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide methods and systems for allocating shared portion of Transmission Opportunity (TXOP) within a Coordinated Time Division Multiple Access (Co-TDMA) scheme.

Additional aspects will be set forth in part in the description which follows and, in part, will be apparent from the description, or may be learned by practice of the presented embodiments.

In accordance with an aspect of the disclosure, a method performed by a device for allocating a shared portion of transmission opportunity (TXOP) within a coordinated time division multiple access (Co-TDMA) scheme is provided. The method includes identifying, by the device, a set of parameters corresponding to each of dynamic data traffic characteristic and channel access characteristic, generating, by the device, allocation rules based on a combination of each of the set of parameters, the allocation rules including a predefined set of profiles indicative of functional relationships among the set of parameters, transmitting, by the device, to a plurality of neighboring access points (APs) participating in a Co-TDMA scheme, the allocation rules through at least one communication frame, initiating, by the device, a negotiation of the allocation rules with at least one neighboring AP of the plurality of neighboring APs participating in the Co-TDMA scheme to determine one or more candidate APs from the plurality of neighboring APs for the Co-TDMA scheme, based on a response from each of the plurality of neighboring APs to the allocation rules, and determining, by the device, one AP from the one or more candidate APs for allocating the TXOP, based on a predefined AP selection procedure associated with the dynamic traffic characteristic parameters and channel access characteristic parameters.

In accordance with another aspect of the disclosure, a device designed for allocating a shared portion of transmission opportunity (TXOP) within a coordinated time division multiple access (Co-TDMA) scheme is provided. The device includes memory, including one or more storage media, for storing instructions and one or more processors communicatively coupled to the memory, wherein the instructions, when executed by the one or more processors individually or collectively, cause the device to identify a set of parameters corresponding to each of dynamic data traffic characteristic and channel access characteristic, generate, allocation rules based on a combination of each of the set of parameters, the allocation rules including a predefined set of profiles indicative of functional relationships among the set of parameters, transmit to a plurality of neighboring Access Points (APs) participating in a Co-TDMA scheme, the allocation rules through at least one communication frame, initiate a negotiation of the allocation rules with at least one neighboring AP of the plurality of neighboring APs to determine one or more candidate APs from the plurality of neighboring APs for the Co-TDMA scheme, based on a response from each of the plurality of neighboring APs to the allocation rules, and determine one AP from the one or more candidate APs for allocating the TXOP, based on a predefined AP selection procedure associated with the dynamic traffic characteristic parameters and channel access characteristic parameters.

In accordance with another aspect of the disclosure, one or more non-transitory computer-readable storage media storing one or more computer programs including computer-executable instructions that, when executed by one or more processors of an device for allocating shared portion of transmission opportunity (TXOP) within a coordinated time division multiple access (Co-TDMA) scheme, individually or collectively, cause the device to perform operations are provided. The operations include identifying a set of parameters corresponding to each of dynamic data traffic characteristic and channel access characteristic, generating, allocation rules based on a combination of each of the set of parameters, the allocation rules including a predefined set of profiles indicative of functional relationships among the set of parameters, transmitting, to a plurality of neighboring access points (APs) participating in a Co-TDMA scheme, the allocation rules through at least one communication frame, initiating a negotiation of the allocation rules with at least one neighboring AP of the plurality of neighboring APs participating in the Co-TDMA scheme to determine one or more candidate APs from the plurality of neighboring APs for the Co-TDMA scheme, based on a response from each of the plurality of neighboring APs to the allocation rules, and determining one AP from the one or more candidate APs for allocating the TXOP, based on a predefined AP selection procedure associated with the dynamic traffic characteristic parameters and channel access characteristic parameters.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE ACCOMPANYING DRAWINGS

The above and other aspects, features, and advantages of certain embodiments of the disclosure will be more apparent from the following description, taken in conjunction with the accompanying drawings, in which:

FIG. 1A illustrates an architecture for a Co-TDMA multi-AP coordination scheme according to an embodiment of the disclosure;

FIG. 1B depicts an environment in which techniques of the disclosure may be implemented according to an embodiment of the disclosure;

FIG. 2 illustrates a block diagram of a device for allocating shared Transmission Opportunity (TXOP) within a Coordinated Time Division Multiple Access (Co-TDMA) scheme according to an embodiment of the disclosure;

FIG. 3A illustrates a hierarchical relationship among various profiles depicting their mapping according to an embodiment of the disclosure;

FIG. 3B illustrates a structure of information elements of allocation rules within a Co-TDMA scheme according to an embodiment of the disclosure;

FIG. 4A illustrates a message sequence chart using Multi-Access Point Coordination (MAPC) Discovery frame according to an embodiment of the disclosure;

FIG. 4B illustrates a message sequence chart using MAPC Negotiation Request frame according to an embodiment of the disclosure;

FIG. 4C illustrates a re-negotiation process for terms of proposed allocation rule according to an embodiment of the disclosure;

FIG. 4D illustrates a message sequence chart using Initial Control Frame (ICF) for Polling phase according to an embodiment of the disclosure;

FIG. 5 illustrates a format of three messages according to an embodiment of the disclosure;

FIG. 6 illustrates a flowchart for selecting an optimal AP out of multiple responding APs according to an embodiment of the disclosure; and

FIG. 7 shows a flowchart illustrating a method of allocating shared portion of Transmission Opportunity (TXOP) within a Coordinated Time Division Multiple Access (Co-TDMA) scheme according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The terms “comprises,” “comprising”, “includes”, or any other variations thereof, are intended to cover a non-exclusive inclusion, such that a setup, device, or method that comprises a list of components or operations does not include only those components or operations but may include other components or operations not expressly listed or inherent to such setup or device or method. In other words, one or more elements in a system or apparatus proceeded by “comprises . . . a” does not, without more constraints, preclude the existence of other elements or additional elements in the system or method.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the disclosure. The following description is, therefore, not to be taken in a limiting sense.

### Overview

Referring to the problem statement described in the background section, the disclosure describes a system and method to support fairness in shared TXOP within Co-TDMA multi-AP scheme by defining a proposed allocation rules (based on traffic and channel access characteristics) that is allowed for the data transmission within the shared portion of the TXOP. Further the proposed system identifies the various signalling options and formats to incorporate the proposed allocation rule and describes the operations per scenario. Also, the disclosure designs an efficient shared TXOP system (in Co-TDMA scheme) wherein an informed AP, that can actually comply with the fairness criteria, gets to participate in Co-TDMA negotiations and Polling phase thereof.

In an embodiment, a sharing AP that intends to share a portion of the obtained TXOP is identified. A proposed allocation of rules for allowed traffic and channel access characteristics, which are applicable during the shared TXOP, is defined. The above defined allocation rules may be transmitted, by the sharing AP, as per three modes:
Option.1 Broadcast mode
Option.2 Multicast mode
Option.3 Unicast mode

The above defined allocation rules may be included in three frame formats:
Option.1 Transmitting in MAPC Discovery frame
Option.2 Transmitting in MAPC Negotiation Request frame
Option.3 Transmitting in Initial Control Frame (ICF) of Polling phase

In an embodiment, any attempt for re-negotiation of the terms of rules may be handled while using MAPC Negotiation Request/Response frames.

In an embodiment, the disclosure proposes allocation rules for the shared TXOP. The allocation rules is supposed to be included by the sharing AP as a sub-element field under the MAPC scheme field for Co-TDMA.

In an embodiment, the purpose of the allocation rules is to provide:

A first set of parameters that cover a wide range of traffic characteristics, and their ranges, for the allowed data transmission during the shared TXOP by the shared/coordinated AP.

A second set of parameters that cover a wide range of channel access characteristics, and their ranges, to be used during the shared TXOP by the shared/ coordinated AP.

A mapping, by indexes, between the parameters of the first and second set, wherever applicable.

In an embodiment, the rule parameter set contains two parts.

First part contains parameters and their ranges for allowed traffic characteristics, namely:

Stream Classification Service (SCS) profile: each profile comprises of fields such as (i)data rate, (ii)Quality of Service (QoS) element, (iii) Traffic Identifier (TID) (or Traffic Stream ID(TSID)) and optionally (iv)User Priority (UP) fields and their corresponding range values (min, max).

QoS element field is further mapped to allowed QoS profiles.

TID/TSID field is further mapped to allowed TID profiles.

QoS profile: each profile comprises of fields such as (i)latency i.e., delay bound in ms, (ii)jitter in ms and (iii) reliability i.e., max number of retransmissions allowed or packet error rate acceptable etc.

TID profile: each profile provides mapping index to allowed access categories (ACs).

Second part contains parameters and their ranges for allowed channel access characteristics, namely: AC profile: each profile (corresponding to ACs such as voice, video, best effort, background, reserved for future) comprises of fields such as (i)Arbitration Inter Frame Spacing(AIFS), (ii)Contention Window minimum (CWmin) and (iii)Contention Window maximum (CWmax) and their corresponding range values (min, max). This profile allows reserved space for future Access Categories as well.

In an embodiment, the AP1 is the sharing AP that obtains the TXOP and intends to share a portion of TXOP to the interested and suitable neighbour APs wherein AP2 and AP3 comprise the set of candidate neighbour APs for Co-TDMA operation.

In an embodiment, the AP1 transmits the below information in the MAPC Discovery frame: Its capability support for Co-TDMA scheme. Optionally, its capability support for other MAPC scheme.

Proposed allocation rule for MAPC scheme: Co-TDMA::Rules for Co-TDMA::allowed traffic and channel access characteristics in the shared TXOP.

The AP1 also receives the MAPC capability advertisement(s) of neighbour APs via their baseline MAPC Discovery frame(s) to identify Co-TDMA capable AP.

The AP2 and AP3 parse the allocation rule for shared TXOP, as received from AP1, to identify and judge if their corresponding traffic and channel access requirements fall within the sharing AP's rule or not.

As an example, AP2 sends an MAPC Negotiation Request frame to AP1 indicating its interest in Co-TDMA scheme (also suggesting that AP2's traffic and channel access requirement has some match to AP1's declared allocation rule) and to negotiate an agreement with AP1 for the same.

The AP1 sends an MAPC Negotiation Response frame to AP2 including ‘accept’ as response for an acceptable agreement honouring the proposed allocation rule.

Alternatively, as another example, AP1 may also send an MAPC Negotiation request frame to Co-TDMA capable neighbour AP3 to find out its interest for Co-TDMA agreement.

Since AP3 has already parsed and judged that proposed allocation rules is not matching with AP3's traffic and channel access requirements, hence it has already decided not to participate in Co-TDMA with AP1 at this time. Accordingly, AP3 sends an MAPC Negotiation Response frame with ‘reject’ value.

Followed by the next phases of Polling and TXOP allocation between sharing AP1 and shared/coordinated AP2.

In an embodiment, AP1 is the sharing AP that obtains the TXOP and intends to share a portion of TXOP to the interested and suitable neighbour APs wherein AP2 and AP3 comprise the set of candidate neighbour APs for Co-TDMA operation.

In an embodiment, the AP1 and AP2, AP3 transmit the baseline MAPC Discovery frame(s) including default information such as capability support for Co-TDMA and, optionally, other schemes respectively to each other but does not contain any proposed allocation rule in it.

The AP2 sends baseline MAPC Negotiation Request frame to share AP1 without any prior information about rule set yet.

The AP1 sends an MAPC Negotiation Response frame to AP2 and may include ‘reject’ as response for a non-acceptable agreement not matching its proposed allocation rule which is yet unknown to AP2.

Alternatively, as another example, AP1 may also send an MAPC Negotiation Request frame including the proposed allocation rule to Co-TDMA capable neighbour AP3 to find out its interest for Co-TDMA agreement.

AP3 parses the proposed allocation rule for shared TXOP, as received from AP1, to identify and judge if its corresponding traffic and channel access requirements fall within the sharing AP's rule or not.

If AP3 can adhere to match at least a minimum of characteristics with the sharing AP's proposed allocation rule then it sends baseline MAPC Negotiation Response frame to AP1 including ‘accept’ as response for an acceptable agreement honouring the proposed allocation rule. Followed by the next phases of Polling and TXOP allocation between sharing AP1 and shared/coordinated AP3.

Further, it may be noted that by including the proposed allocation rule in MAPC Negotiation related frames, provides an additional advantage that even if the initial terms of rule (as transmitted by sharing AP) may not be acceptable to candidate shared AP leading to ‘rejection’ of the agreement between the two APs—there may be a possibility for ‘another round of re-negotiation’ based on ‘certain conditions’ which may be acceptable to both APs and thus helps both of them to benefit from Co-TDMA scheme.

In an embodiment, the AP1 is the sharing AP that obtains the TXOP and intends to share a portion of TXOP to the interested and suitable neighbour Aps, wherein AP2 is a candidate neighbour AP for Co-TDMA operation.

In an embodiment, the AP1 sends MAPC Negotiation Request frame including the proposed allocation rule to Co-TDMA capable neighbour AP2 to find out its interest for Co-TDMA agreement.

The AP2 parses the received allocation rule from AP1 and judges that proposed allocation rule is not matching with AP2's traffic and channel access requirements, hence it decides not to participate in Co-TDMA with AP1 at this time. Accordingly, AP2 sends an MAPC Negotiation Response frame with ‘reject’ value.

OPTION-1: observing that none of the neighbour APs are agreeing to adhere with the proposed allocation rule of sharing AP1, AP1 may decide to modify one/more parameter/mapping from proposed allocation rule so as to increase the probability of agreement negotiation (i.e. re-negotiation) being a success with neighbour APs and thus benefitting from the Co-TDMA scheme. Accordingly, AP1 sends an MAPC Negotiation Request frame including the modified proposed allocation rule to Co-TDMA capable neighbour AP2 to re-assess its interest for Co-TDMA agreement.

The AP2 parses the received modified allocation rule from AP1 and judges that proposed allocation rule is now matching with AP2's traffic and channel access requirements to some extent, hence it decides to participate in Co-TDMA with AP1 at this time. Accordingly, AP2 sends an MAPC Negotiation Response frame with ‘accept’ as response for an acceptable agreement honouring the proposed allocation rule.

OPTION-2 (alternate): observing that AP2 is not able to adhere with the proposed allocation rule of sharing AP1, if AP2 can manage some leniency in its requirements within acceptable limits, then it may modify one/more of its requirement parameters to have at least a minimum match with the sharing AP's proposed allocation rule so as to benefit from the Co-TDMA scheme. Accordingly, AP2 sends baseline MAPC Negotiation Request frame with modified agreement (for re-negotiation) parameters to AP1 to re-assess possibility of an acceptable Co-TDMA agreement.

The AP1 sends an MAPC Negotiation Response frame to AP2 including ‘accept’ as response for an acceptable agreement honouring the proposed allocation rule.

In an embodiment, the AP1 is the sharing AP that obtains the TXOP and intends to share a portion of TXOP to the interested and suitable neighbour Aps, wherein AP2 and AP3 comprise the set of candidate neighbour APs for Co-TDMA operation. In this embodiment, the MAPC capability advertisement and discovery, esp. for Co-TDMA scheme, occurs between AP1, AP2 and AP3.

Basic negotiation and agreement has taken place between AP1-AP2 and AP1-AP3, wherein AP2 and AP3 have agreed to participate in Co-DTMA scheme with sharing AP1.

Within the start of Polling phase, AP1 sends an Initial Control Frame(ICF) including the proposed allocation rule to all participant APs.

Participant APs (i.e., AP2 and AP3) parse the proposed allocation rule, which is applicable for traffic and channel access characteristics allowed within this shared TXOP, and judge whether they match with the criteria.

Both AP2 and AP3 match with at least some criteria within proposed allocation rule and accordingly send an Initial Control Response frame(ICR) with ‘accept’ as response to AP1 thereby agreeing that both of them can make use of the shared portion within this TXOP.

Followed by the TXOP allocation phase wherein AP1 decides one among AP2 and AP3 with whom it would share the TXOP and initiates dedicated signalling accordingly for shared TXOP allocation.

In an embodiment, (a) MAPC Discovery frame, (b) MAPC Negotiation Request frame and (c) ICF for Polling phase, as explained below:

In (a) MAPC Discovery frame, format of MAPC Discovery frame is shown as per latest standard draft. The MAPC scheme specific information field (MAPC Schemes Info) is utilized within the Discovery MAPC Element field of the frame. In the presence of Co-TDMA as a supported scheme, MAPC Schemes Info field (corresponding to specific Co-TDMA scheme) shall contain one another subfield which shall contain the proposed allocation rule for Co-TDMA.

In (b) MAPC Negotiation Request frame, format of MAPC Negotiation Request frame is shown as per latest standard draft. The MAPC scheme specific information field (MAPC Schemes Info) is utilized within the Negotiation MAPC Element field of the frame. In the presence of Co-TDMA as a supported scheme, MAPC Schemes Info field (corresponding to specific Co-TDMA scheme) shall contain one another subfield which shall contain the proposed allocation rule for Co-TDMA.

In an embodiment, the most probable candidate recognized in standards group for the same is the Buffer Status Report Poll trigger frame (BSRP-TF).

So, considering BSRP-TF as an example, in (c) with Co-TDMA as a supported scheme, the Common Info field of the ICF frame such as BSRP-TF, shall contain one another subfield which shall contain the proposed allocation rule for Co-TDMA.

As described in the background, existing Co-TDMA based multi-AP coordination schemes fail to ensure fairness in sharing the Transmission Opportunity (TXOP) because they rely on limited parameters, lack adaptability, and provide no mechanism for dynamic re-negotiation of sharing conditions.

The disclosure therefore provides a method and device that identify relevant traffic and channel-access characteristic parameters, define their functional relationships through a structured allocation rule, and specify signaling mechanisms for exchanging these rules among APs. The disclosure further enables bi-directional negotiation and re-negotiation of the allocation rule and introduces a systematic AP-selection procedure based on predefined comparison criteria to identify the optimal candidate AP for shared TXOP allocation. Through these techniques, the disclosure ensures that only an informed AP capable of complying with fairness requirements participates in Co-TDMA negotiations and polling, thereby enabling an efficient and equitable shared-TXOP system. This leads to a more efficient, fair, and adaptive shared TXOP system in multi-AP environments, particularly under dynamic wireless traffic conditions.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

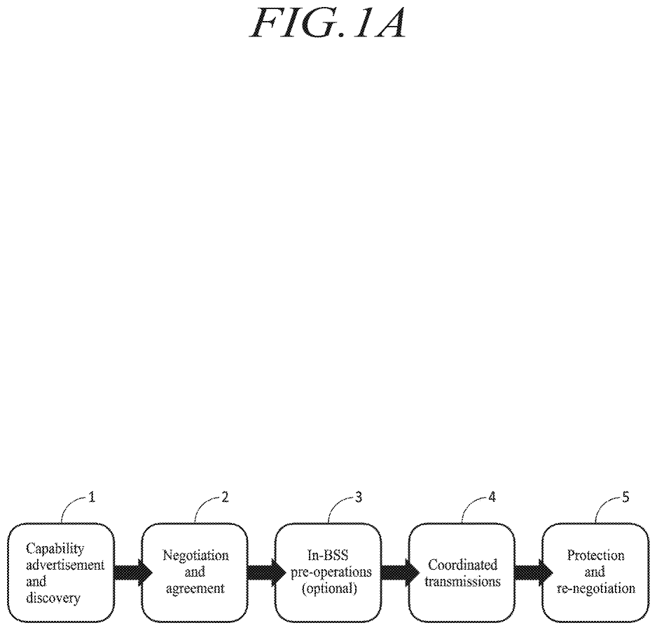

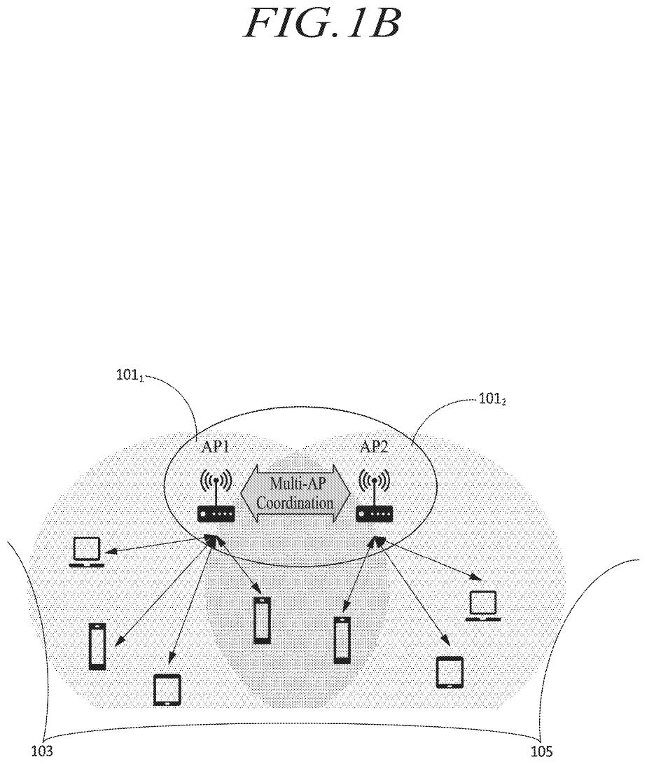

FIG. 1A illustrates an architecture for a Co-TDMA multi-AP coordination scheme according to an embodiment of the disclosure.

Referring to FIG. 1A, a broad block diagram comprising five main components, each addressing distinct aspects of the proposed system is illustrated. The first component, denoted by reference numeral 1, is the “Capability Advertisement and Discovery.” This component initiates the Co-TDMA coordination process, whereby Access Points (APs) broadcast their respective capabilities. Neighboring APs listen and analyze these broadcasts to identify potential partners interested in participating in the Co-TDMA scheme. The functionality of this block is critical for establishing initial communication and determining compatibility among APs.

The second component, referred to as numeral 2, is the “Negotiation and Agreement.” In this phase, the identified APs engage in a negotiation process to reach mutual agreements on the terms of coordination, including the specific rules for sharing the Transmission Opportunity (TXOP). This block ensures that all participating APs understand their respective roles and responsibilities, thus setting the groundwork for effective collaboration in utilizing available channel resources.

The third component, labeled 3, represents “In-BSS Pre-Operations,” which is an optional operation. Should the participating APs deem it necessary, they can prepare the necessary internal operations within their Basic Service Set (BSS) before proceeding on the coordinated transmission phase.

The fourth component, marked with numeral 4, is “Coordinated Transmissions.” In this phase, the APs execute their transmissions in a coordinated manner based on the previously established agreements. This functionality is fundamental, as it leverages optimized channel usage and minimizes interference among APs, thereby enhancing overall network efficiency and performance.

The fifth and last component, referred to as 5, is “Protection and Re-Negotiation.” This element safeguards the coordination setup, ensuring that any changes in operating conditions are managed efficiently. If necessary, the APs can initiate re-negotiations to adjust the terms of coordination to reflect evolving network dynamics and requirements. This ongoing adaptability is vital for maintaining operational efficiency in the Co-TDMA scheme, particularly in dynamic environments.

Data and signal flow among these components follows a logical sequence, starting with capability advertisement and discovery, moving through negotiation, and culminating in coordinated transmissions. Each transition occurs based on the successful completion of the preceding block, establishing a clear communication path where each component informs and interacts with the successive operation.

In an embodiment, all components can be realized through a combination of hardware and software approaches, aligning with current standards in network communications. For instance, the capability advertisement may utilize specific communication frames, while the negotiation phase may involve software-defined protocols for facilitating interactions among APs.

In some embodiments, optional components or alternative implementations may be integrated to enhance system functionality. For example, variations in negotiation strategies may be employed to accommodate differing priority levels among APs while still falling within the intended scope of the disclosure. Such flexibility in the implementation reinforces the device's adaptability to various networking scenarios.

FIG. 1B depicts an environment in which the techniques of the disclosure may be implemented according to an embodiment of the disclosure.

Referring to FIG. 1B, an environment illustrates a multi-Access Point (AP) coordination system operating within a wireless network where multiple client devices such as laptops, tablets, and smartphones (as shown 103 connected with AP1 101₁ and 105 connected with AP2 101₂) connect through two APs, namely AP1 101₁ and AP2 101₂. In the context of the disclosure, this environment demonstrates how participating APs exchange traffic-related and channel-access-related parameters to support fair and informed allocation of a shared Transmission Opportunity (TXOP). AP1 101₁ may function as a sharing AP that has acquired a TXOP, while AP2 represents a neighboring AP evaluating its eligibility to utilize the shared portion based on the proposed allocation rule communicated by AP1 101₁.

In conventional Co-TDMA systems, APs may coordinate only through limited signalling and without considering comprehensive traffic characteristics, leading to unfair access and inefficient use of shared TXOPs. Moreover, traditional approaches lack mechanisms for structured negotiation or re-negotiation of sharing conditions, causing APs with insufficient capability or incompatible traffic requirements to participate, thereby degrading overall network performance. As such, existing deployments are unable to dynamically and fairly determine which neighboring AP should receive access to the shared portion of a TXOP.

In accordance with the disclosure, the coordination environment shown in FIG. 1B incorporates enhanced signaling mechanisms such as MAPC Discovery frames, Negotiation Request/Response frames, and Initial Control Frames that allow AP1 101₁ to communicate a predefined “allocation rule” to AP2 101₂. These rules describe permitted traffic characteristics (e.g., latency, jitter, reliability, data rate, user priority) and channel-access characteristics (e.g., AC, Arbitration Inter Frame Space Number (AIFSN), CWmin, CWmax) applicable during the shared TXOP. AP2 101₂ evaluates these rules against its own dynamic conditions to determine whether it is a qualified candidate AP. If AP2 101₂ is unable to comply, the system supports bi-directional negotiation and re-negotiation of parameters, enabling the APs to reach mutually acceptable TXOP-sharing conditions.

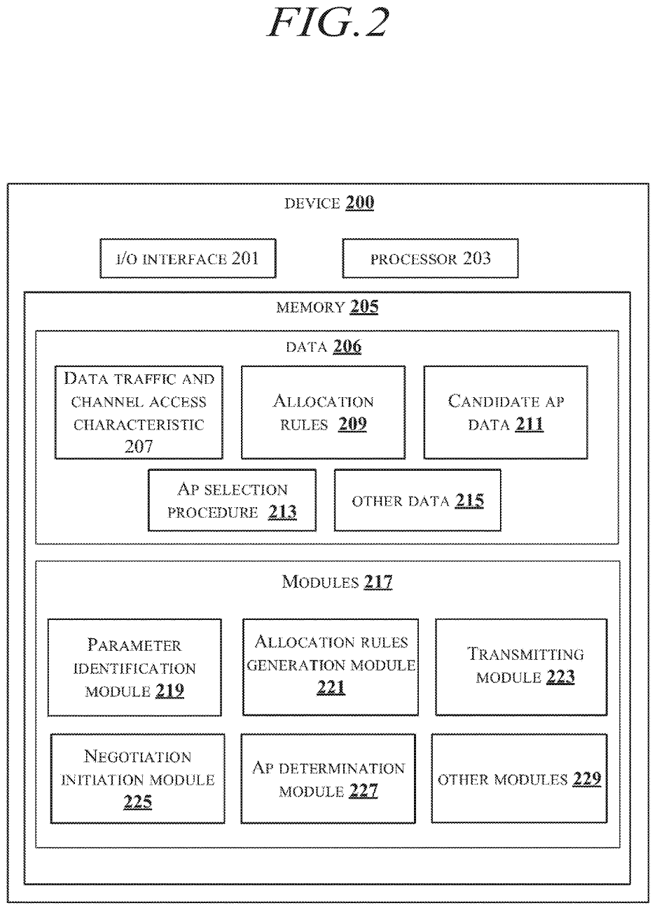

Herein, AP1 and AP2 each operate within respective Basic Service Set (BSS) areas. The figure shows overlapping coverage regions in which client devices can detect signals from both APs, thereby making coordinated transmissions essential for minimizing interference and maintaining fairness. In the environment of the disclosure, APs operating within such overlapping regions utilize the proposed allocation rule and AP-selection procedure to ensure that only an AP satisfying the fairness criteria participates in the polling phase and ultimately receives access to the shared TXOP. A detailed description of the functioning of the device and signalling operations used in FIG. 2 is provided in the upcoming paragraphs in conjunction with FIGS. 2, 3A, 3B, 4A to 4D, and 5 to 7.

FIG. 2 illustrates a detailed block diagram of a device designed for allocating a shared portion of Transmission Opportunity (TXOP) within a Coordinated Time Division Multiple Access (Co-TDMA) scheme according to an embodiment of the disclosure.

Referring to FIG. 2, a device 200 comprises several interconnected components that collectively support efficient data handling, traffic management, and multi-AP coordination necessary for fair TXOP sharing. In some embodiments, the device 200 may comprise an input-output (I/O) interface 201, a processor 203, memory 205, and a plurality of functional modules. The I/O interface 201 facilitates communication between the device 200 and external systems, enabling transmission and reception of data exchanged during Co-TDMA operations. The processor 203 may be configured to execute instructions stored in the memory 205 and perform one or more operations associated with parameter identification, allocation rule generation, negotiation handling, and AP determination.

In some implementations, the processor 203 may be configured to perform one or more functions of the device 200, using data 206 and modules 217 of the device 200. In an embodiment, the memory 205 may store the data 206.

In some embodiments, the data 206 stored in the memory 205 may include, without limitation, data traffic, and channel Access characteristics data 207, allocation rules 209, candidate AP data 211, AP selection procedure 213 and other data 215. In some implementations, the data 206 may be stored within the memory 205 in the form of various data structures. The other data 215 may include various temporary data and files generated by the modules 217.

In an embodiment, the data 206 may be processed by the modules 217 of the device 200. In some implementations, the modules 217 may be communicatively coupled to the processor 203 for performing one or more functions of the device 200. In an implementation, the modules 217 may include, without limiting to, a parameter identification module 219, an allocation rules generation module 221, a transmitting module 223, a negotiation initiation module 225, AP determination module 227, and other modules 229.

As used herein, the term “module” refers to any identifiable portion of a system, device, or process that is configured to perform one or more specific functions. A module may be implemented in hardware, software, firmware, or any combination thereof. A module need not be physically or logically separated from other modules or components and may reside on a single device or be distributed across multiple devices or systems. The term is intended to be interpreted broadly to encompass any functional element capable of performing the described operations, regardless of its structural form or implementation details. In an embodiment, the other modules 229 may be used to perform various miscellaneous functionalities on or of the device 200. It will be appreciated that the modules may be represented as a single module or a combination of different modules.

The data traffic and channel Access characteristics data 207 may comprise all traffic-related and channel-access-related parameters that describe the current network conditions for an Access Point (AP) that is generating or evaluating TXOP-sharing rules. The data traffic and channel Access characteristics data 207 includes values representing User Priority (UP), latency requirements, jitter requirements, reliability requirements, data-rate requirements, Access Category (AC), Arbitration Inter-Frame Space Number (AIFSN), and minimum and maximum Contention Window values (CWmin and CWmax).

The allocation rules 209 may comprise predefined allocation of rules used for allocation of TXOP. The allocation rules 209 details regulations governing resource allocation within the device 200. The allocation rules 209 comprise predefined set of profiles indicative of functional relationships among the set of parameters. It includes a set of structured profiles, such as SCS profile containing TID, TSID, UP, and data rate, QoS profile containing latency, jitter, and reliability requirements, a TID profile defining allowed access categories, and an AC profile specifying AIFS, CWmin, and CWmax. The allocation rules 209 also contain mapping indices that describe how these profiles relate to each other, along with the parameters defining the allowed traffic characteristics and channel-access constraints applicable during the shared portion of the TXOP. The allocation rules 209 is the format communicated to neighboring APs during signalling operations and is used in both negotiation and re-negotiation procedure.

The candidate AP data 211 comprise information received from neighboring APs in response to the allocation rules communicated by the sharing AP. Particularly, the candidate AP data 211 may accumulate qualifications of potential APs for participation in Co-TDMA resource sharing. Accordingly, the candidate AP data 211 comprise responses of neighboring APs whether accepting or rejecting the allocation rule along with the parsed traffic-related and channel-access-related parameters reported by those APs. It also stores the results of compatibility checks, eligibility indicators showing whether the AP meets the required thresholds, negotiation responses conveyed through MAPC signalling, and identifiers and capability information of APs willing to participate in the Co-TDMA procedure.

The AP selection procedure 213 comprise a criteria, comparison ordering, and evaluation logic used for determining the optimal/suitable AP among the candidate APs identified. The AP selection procedure 213 particularly contains the predefined selection procedures used for comparing APs. As such, the AP selection procedure 213 includes the ordered sequence of comparison criteria, covering parameters such as access category, AIFSN, CWmin, CWmax, latency requirement, reliability requirement, data-rate capability, and jitter requirement. It further contains the rules governing pairwise comparisons, the elimination and ranking logic for resolving differences in AP capabilities.

Finally, the other data 215 may comprise miscellaneous, temporary, and auxiliary data generated during device operation. The other data 215 may contain temporary data and files generated by the modules, which include temporary negotiation data, cached MAPC signalling frames, runtime state information associated with rule generation or parsing, intermediate computational values generated during the AP-selection process, buffer data used during real-time traffic evaluation and debugging or logging information. These pieces of data support the internal operational workflows of the system, even though they do not form part of the long-term stored rule or parameter datasets.

In some embodiments, the parameter identification module 219 is configured to identify the set of parameters that correspond to dynamic data-traffic characteristics and channel-access characteristics. The set of parameters comprises a first set of parameters relating to a plurality of traffic characteristics, and their ranges, for an allowed data transmission during the shared TXOP by a coordinated AP identified from a plurality of neighboring AP, and a second set of parameters relating to a plurality of channel access characteristics, and their ranges, for sharing the TXOP by the coordinated AP. Particularly, the parameter identification module 219 identifies necessary parameters that govern both data traffic and channel access characteristics relevant for allocation rules generation. The parameter identification module 219 may process stored traffic-related attributes such as user priority, latency, jitter, reliability, and data rate requirements, along with channel-access parameters such as access category (AC), Arbitration Inter-Frame Space Number (AIFSN), CWmin, and CWmax. By extracting these inputs from the data 206 stored in memory 205, the parameter identification module 219 ensures that all parameters influencing fairness, traffic behavior, and medium access are correctly identified.

The allocation rules generation module 221 is configured to generate allocation rules based on a combination of each of the set of parameters identified by the parameter identification module 219. The allocation rules comprise a predefined set of profiles indicative of functional relationships among the set of parameters. The allocation rules generation module 221 may generate specific rules and profiles that guide the data allocation process, reflecting a combination of identified parameters related to user priorities, latency requirements, and channel access specifications. In doing so, the allocation rules generation module 221 classifies each of the set of parameters into predefined profiles, such as, the Stream Classification Service (SCS) profile, Quality of Service (QoS) profile, Traffic Identifier (TID) profile, and Access Category (AC) profile. Further, the allocation rules generation module 221 may determine mapping indices between these profiles to establish functional relationships among parameters.

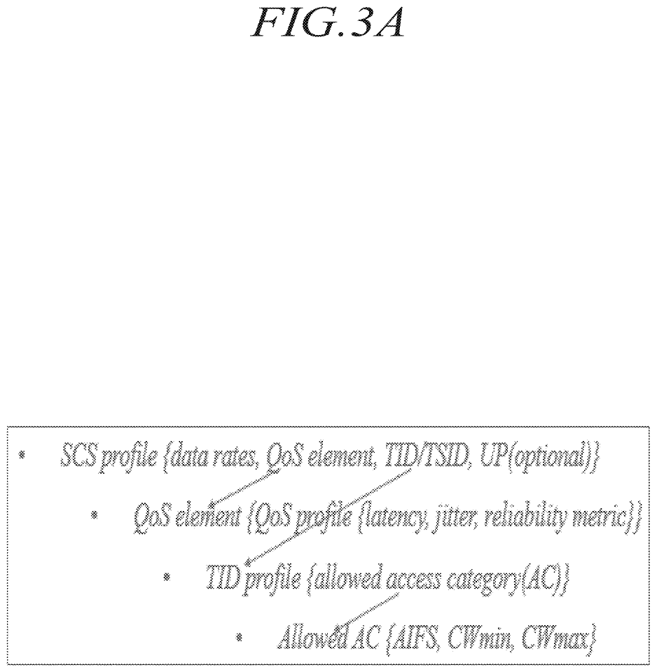

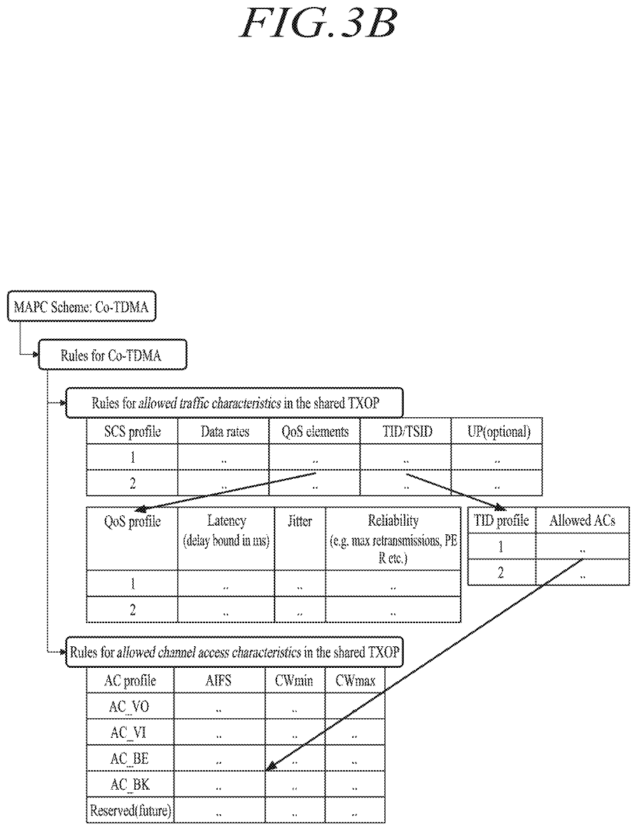

FIG. 3A illustrates a hierarchical relationship among various profiles, including the Stream Classification Service (SCS) profile, Quality of Service (QoS) profile, Traffic Identifier (TID) profile, and Access Category (AC) profile, illustrating their mapping according to an embodiment of the disclosure.

Referring to FIG. 3A, the first profile, labeled as SCS profile encompasses fundamental transmission characteristics, including data rates and essential Quality of Service (QoS) elements such as Traffic Identifier (TID), Traffic Stream Identifier (TSID), and optionally User Priority (UP). The SCS profile is critical as it provides definitions for data transmission necessary to adapt to the unique requirements of various network applications, facilitating differentiated service levels based on user needs.

The second profile, termed “QoS element,” encapsulates specific QoS metrics, particularly latency, jitter, and reliability metrics. These metrics ensures that services meet the required performance standards necessary for applications sensitive to delays or data losses, thus providing a benchmark for expected performance in different scenarios.

The third profile represented is the “TID profile,” which specifies the allowable access categories (AC) within the system. This profile plays a vital role by categorizing traffic types, thus enabling prioritization based on pre-defined traffic characteristics. By defining allowed ACs, this profile helps in efficiently allocating resources to ensure high-priority applications receive the requisite service levels.

The fourth profile, “Allowed AC,” describes various access parameters which include Arbitration Inter-Frame Space (AIFS), minimum contention window (CWmin), and maximum contention window (CWmax). This profile influences the access method of the medium, regulating how devices share network resources and thus ensuring fair usage among multiple users in the network.

Data flows among these profiles logically from the SCS profile to the QoS profile, then to the TID profile, and finally to the AC profile. Each profile interacts with the preceding block to inform the parameters that govern the processing of data and the allocation of network resources. For instance, parameters defined in the SCS profile may dictate the specific QoS metrics needed, which then aligns with the TID requirements for traffic prioritization before finalizing access category assignments.

Optional components or alternative implementations may include additional profiles or parameters that can extend the functionality of this mapping. For example, introducing further QoS metrics or more granular access categories within the TID profile may enhance adaptability. Such flexibility allows the system to cater to evolving network demands while ensuring compliance with established fairness methodologies in Co-TDMA schemes.

FIG. 3B illustrates a structure of information elements of allocation rules within the Co-TDMA scheme according to an embodiment of the disclosure. The structure comprises the starting point where the presentation of the Multi-Access Point Coordination (MAPC) scheme specifically designed for Coordinated Time Division Multiple Access (Co-TDMA) is made.

Referring to FIG. 3B, the proposed allocation rule introduces the rule parameter set as a sub-element under the MAPC scheme field for Co-TDMA, and this rule parameter set is structured into two distinct set of parameters. The first set specifies the parameters and their allowable ranges for defining the permitted traffic characteristics within the shared portion of a TXOP. In this set, the SCS profile is defined, wherein each profile includes fields such as data rate, QoS element, Traffic Identifier (TID), or Traffic Stream Identifier (TSID), and optionally the User Priority (UP), along with their respective minimum and maximum range values. The QoS element field of the SCS profile is further mapped to a set of QoS profiles, each of which contains parameters such as latency expressed as a delay bound in milliseconds, jitter expressed in milliseconds, and reliability represented in terms of factors such as the maximum number of retransmissions allowed or acceptable packet error rate. Similarly, the TID or TSID field is mapped to TID profiles, where each TID profile provides an index to the set of Access Categories (ACs) that may be used by the AP during the shared TXOP. Through this structure, the first set of the rule parameters comprehensively defines the allowable traffic behaviors, including their priority levels, transmission constraints, and service requirements.

The second set of the rule parameter set determines the parameters and their allowable ranges for defining the channel-access characteristics permitted during the shared portion of the TXOP. This set introduces the AC profile, where each profile corresponds to an Access Category such as voice, video, best effort, background, or any additional reserved category for future extension. Each AC profile includes fields such as the Arbitration Inter-Frame Spacing (AIFS), the minimum Contention Window (CWmin), and the maximum Contention Window (CWmax), together with their associated min-max range values. This structure ensures that, during the shared TXOP, APs adhere to a clear and consistent definition of channel-access behavior, allowing the Co-TDMA system to maintain fairness, minimize collision opportunities, and enable predictable access characteristics even under dynamic traffic loads. Moreover, by reserving space for future AC profiles, the rule parameter set remains extensible and adaptable to evolving wireless standards and application needs.

Returning to FIG. 2, the transmitting module 223 is configured to transmit the generated allocation rules to the plurality of neighboring Access Points (APs) participating in the Co-TDMA scheme through one or more communication frames. The transmitting module 223 embeds the allocation rules into at least one predefined signalling frames such as, Multi-AP Coordination (MAPC) Discovery frame, a MAPC Negotiation Request frame, and an Initial Control Frame (ICF) of polling phase, and transmits them to all neighboring APs participating in the Co-TDMA scheme.

The negotiation initiation module 225 is configured to initiate and manage negotiation of the allocation rules with at least one neighboring AP of the plurality of neighboring APs participating in the Co-TDMA scheme, to determine one or more candidate APs from the plurality of neighboring Access Points (APs) for the Co-TDMA scheme, based on a response from each of the plurality of neighboring APs to the allocation rules. The negotiation initiation module 225 processes responses received from APs such as acceptance or rejection and triggers bi-directional negotiation when a neighboring AP cannot comply with the initial allocation rule. The negotiation initiation module 225 also enables selective adjustment of the allocation rules based on feedback, thereby supporting dynamic renegotiation. That is, based on the negotiation, when the adjustments are acceptable to the AP, the negotiation initiation module 225 may either receive an acceptance response for the allocation rules by a neighboring AP. Alternatively, when at least one of the plurality of neighboring APs is unable to comply with the allocation rules for sharing the TXOP, the negotiation initiation module 225 may initiate a bi-directional negotiation with the at least one neighboring AP of the plurality of neighboring APs. Herein, on initiating the bi-directional negotiation, the negotiation initiation module 225 may receive responses from the at least one neighboring AP, and selectively adjust the allocation rules based on feedback received during the negotiation, when the adjustments are acceptable to the AP.

The AP determination module 227 is configured to identify the most suitable AP for receiving the shared portion of the TXOP from among the candidate APs. The AP determination module 227 implements the predetermined AP-selection procedure stored in AP selection procedure 213, which includes iterative pairwise comparison of APs based on parameters such as AC, AIFSN, CWmin, CWmax, latency, reliability, data rate, and jitter. The AP determination module 227 evaluates candidates using the ordered comparison rules and eliminates APs until one optimal AP remains. That is, the AP selection procedure is performed by the AP determination module 227 by performing iteratively a pairwise comparison of APs of the one or more candidate APs according to a predefined ordering of comparison criteria, the comparison criteria comprising a channel-access characteristics comparison in which, an AP having a higher access-category (AC), a smaller AIFSN, a shorter CWmin, and a shorter CWmax is selected and a traffic-characteristics comparison in which, an AP having a stricter latency requirement, a higher reliability requirement, a higher data-rate capability, and a stricter jitter requirement is selected. Then, from the one or more candidate APs, the AP determination module 227 selects the AP satisfying each of the channel-access and traffic-characteristic comparison criteria.

The other modules 229 provide additional processing, auxiliary functions, and adaptive operational support for the overall Co-TDMA coordination process. These modules may handle temporary data processing, exception handling, supplementary signal-format parsing, runtime error resilience, dynamic profiling updates, or any additional processes required to maintain seamless coordination among APs. While not directly tied to any single claim element, these modules ensure that the core processes carried out by modules 219, 221, 223, 225, and 227 execute reliably and efficiently within different operating conditions. The other modules 229 may include additional functionalities required to support Co-TDMA operations, such as adaptive handling of atypical scenarios, updates to allocation rules, or supplementary processing required for real-time coordination. These components collectively form an integrated architecture that ensures efficient data traffic management and equitable TXOP allocation.

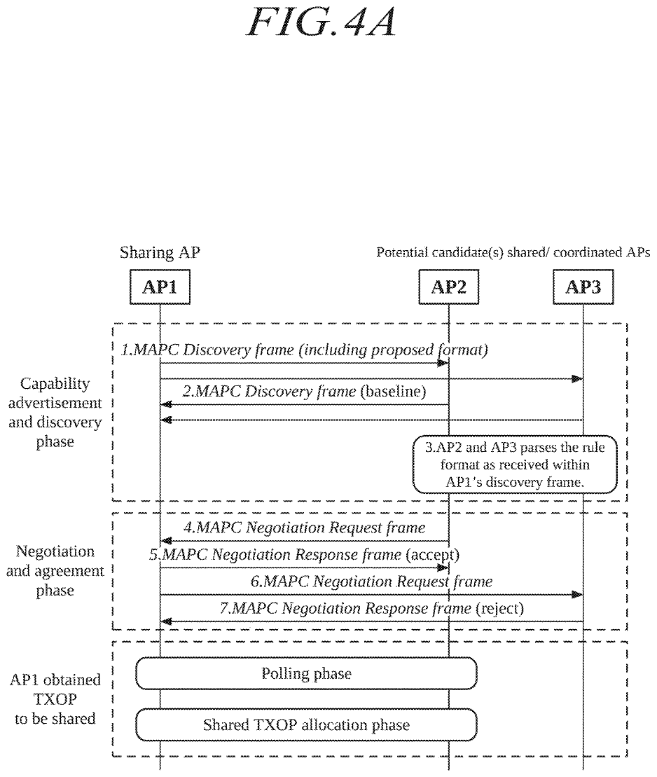

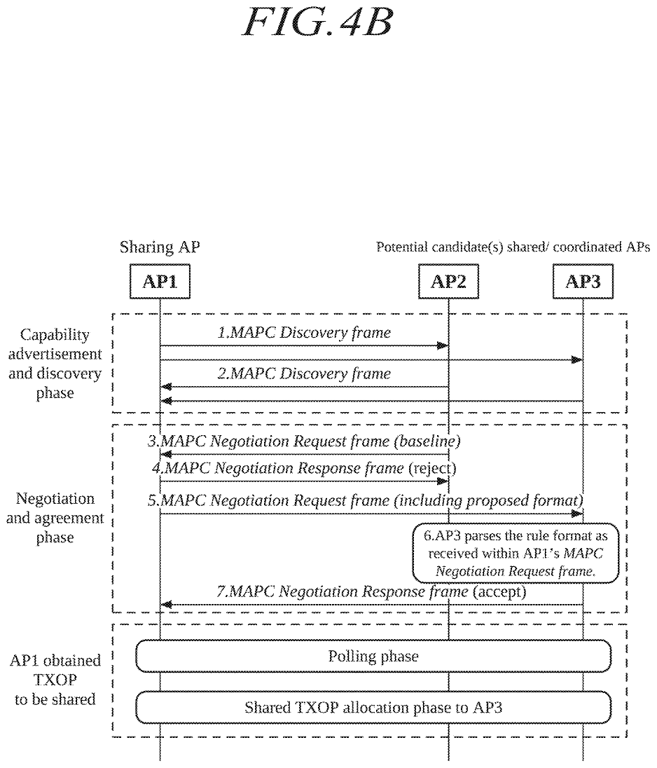

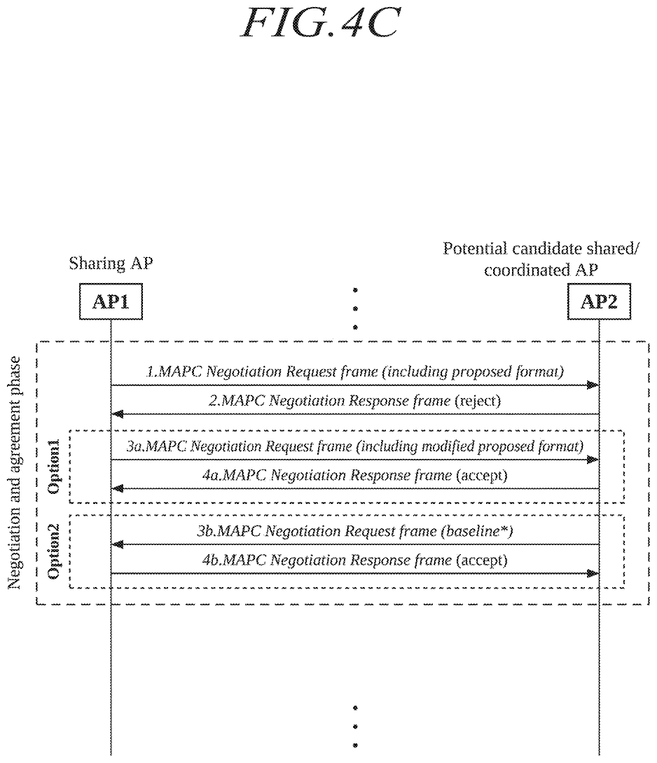

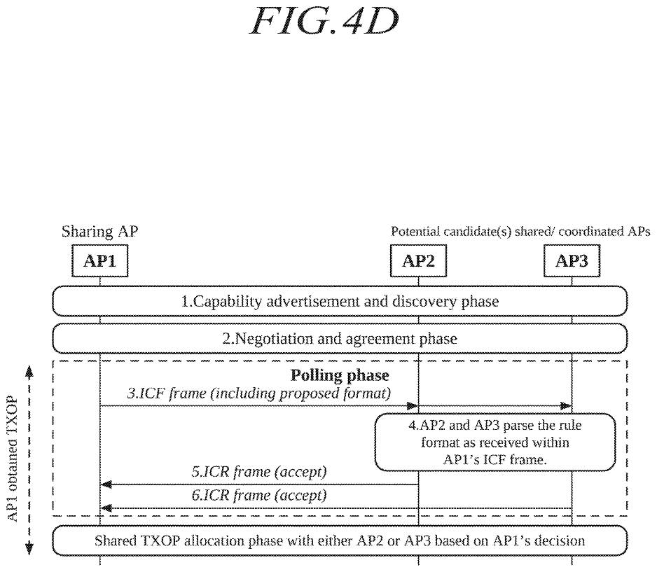

FIG. 4A illustrates a message sequence chart using MAPC Discovery frame according to an embodiment of the disclosure.

Referring to FIG. 4A, the flowchart outlines the sequential operations undertaken by participating APs specifically AP1, AP2, and AP3, to facilitate the sharing of a Transmission Opportunity (TXOP).

Herein, the AP1 serves as the sharing Access Point (AP) that acquires a Transmission Opportunity (TXOP) and intends to share the applicable portion of this TXOP with neighboring APs capable of supporting Co-TDMA, wherein AP2 and AP3 constitute the set of potential candidate APs participating in the Co-TDMA operation. At operation 1, AP1 transmits a MAPC Discovery frame containing its capability support for the Co-TDMA scheme, optionally its support for other MAPC schemes, and the proposed allocation rule defining the allowed traffic characteristics and channel-access characteristics for the shared TXOP. At operation 2, AP1 receives MAPC capability advertisements from neighboring APs via their baseline MAPC Discovery frames, enabling AP1 to identify which APs are Co-TDMA capable and therefore eligible to evaluate the proposed allocation rule. At operation 3, AP2 and AP3 parse the proposed allocation rule received from AP1 to determine whether their respective traffic-related and channel-access-related requirements fall within the parameters defined by AP1's allocation rule, thereby performing the evaluation required before negotiation is initiated.

At operation 4, AP2, upon determining compatibility between its own requirements and AP1's allocation rule, sends a MAPC Negotiation Request frame to AP1 indicating its interest in participating in the Co-TDMA scheme and its readiness to negotiate an agreement. At operation 5, AP1 evaluates AP2's request and responds with a MAPC Negotiation Response frame carrying an “accept” indication, confirming that AP2 meets the conditions defined by the allocation rules. At operation 6, AP1 may also initiate negotiation with another Co-TDMA-capable AP, such as AP3, by transmitting a MAPC Negotiation Request frame to evaluate its potential participation in Co-TDMA coordination. At operation 7, since AP3 has already parsed the allocation rule and determined that its traffic and channel-access characteristics do not comply with AP1's rule parameters, AP3 returns a MAPC Negotiation Response frame with a “reject” indication, thus excluding itself from the set of candidate APs.

Following these operations, the process proceeds to the polling and TXOP allocation phases between AP1 and the accepted coordinated AP2.

FIG. 4B illustrates a message sequence chart using MAPC Negotiation Request frame according to an embodiment of the disclosure.

Referring to FIG. 4B, the flowchart comprehensively outlines a systematic approach involving multiple Access Points (APs), namely AP1, AP2, and AP3, facilitating the sharing of TXOP resources by leveraging a structured negotiation process.

AP1 functions as the sharing AP that acquires a Transmission Opportunity (TXOP) and intends to share a portion of this TXOP with neighboring APs that are capable of participating in a Co-TDMA scheme, wherein AP2 and AP3 represent the set of potential candidate APs for such coordinated operation. At operation 1 and operation 2, AP1, AP2, and AP3 exchange their baseline MAPC Discovery frames containing default capability information, including support for the Co-TDMA scheme and, where applicable, support for other MAPC schemes. These baseline discovery frames do not contain any proposed allocation rule for the shared TXOP and therefore serve only to identify Co-TDMA capable neighboring APs within the overlapping operational environment, consistent with the capability advertisement and discovery phase described in the draft. At operation 3, AP2 initiates negotiation in the absence of prior knowledge of AP1's allocation rule by sending a baseline MAPC Negotiation Request frame to AP1, thereby expressing interest in potential participation in the Co-TDMA procedure.

At operation 4, AP1 evaluates AP2's unsolicited negotiation request and issues a MAPC Negotiation Response frame that may include a “reject” indication, since AP2 has not yet received AP1's proposed allocation rule and cannot be evaluated against it. At operation 5, AP1 may alternatively initiate a negotiation by sending a MAPC Negotiation Request frame that explicitly includes the proposed allocation rule to another Co-TDMA-capable neighboring AP such as AP3, thereby enabling AP3 to carry out an informed compliance evaluation. At operation 6, AP3 parses AP1's proposed allocation rule to determine whether its own traffic-related and channel-access-related requirements fall within the ranges specified by AP1, consistent with the negotiation-and-evaluation flow described for the Co-TDMA scheme. At operation 7, if AP3 determines that it can satisfy at least the minimum traffic and channel-access requirements defined in AP1's allocation rule, it responds with a baseline MAPC Negotiation Response frame containing an “accept” indication, thereby establishing itself as an eligible candidate AP for TXOP sharing under the allocation rules proposed by AP1.

Upon completion of these negotiation operations, the procedure moves into the polling and shared-TXOP allocation phases between AP1 and the coordinated AP which here is, AP3. AP1 subsequently performs AP selection using the predefined AP-selection procedure and allocates the shared portion of TXOP to the most suitable AP based on compliance with the allocation rule and fairness-driven criteria.

FIG. 4C illustrates a re-negotiation process for the terms of proposed allocation rule according to an embodiment of the disclosure. The flowchart delineates the series of operations involved in facilitating the efficient sharing of Transmission Opportunity (TXOP) among APs, notably comprising the sharing AP1, and potential candidate APs AP2 and AP3.

Referring to FIG. 4C, illustrates the re-negotiation capability that arises from embedding the proposed allocation rule directly within MAPC negotiation-related frames. As explained above, the negotiation initiation module enables bi-directional negotiation, allowing APs to adjust allocation rules when initial conditions are unacceptable. This provides a significant advantage, even if a neighboring AP cannot initially comply with the sharing AP's declared allocation rule and must reject the proposal, a renewed round of negotiation remains possible, enabling both APs to agree upon modified parameters and thereby still benefit from Co-TDMA operation. In this context, AP1 acts as the sharing AP that has obtained the TXOP and seeks to share the applicable portion with a neighboring, Co-TDMA-capable AP—here, AP2. The signaling flow in this figure corresponds exclusively to the negotiation and agreement phase.

At operation 1, AP1 sends a MAPC Negotiation Request frame to AP2, this time including the proposed allocation rule, thereby enabling AP2 to evaluate whether its own traffic and channel-access characteristics can comply with AP1's requirements for the shared TXOP. At operation 2, AP2 parses the received allocation rule and determines that its traffic and channel-access characteristics do not fall within AP1's defined parameters. As a result, AP2 decides not to participate in Co-TDMA under the current conditions and returns a MAPC Negotiation Response frame containing a “reject” indication.

### OPTION 1—Re-Negotiation Initiated by AP1

At operation 3a, after observing that none of the neighboring APs are able to adhere to the initially proposed allocation rule including AP2, which has responded with a rejection, AP1 may choose to modify one or more parameters within the allocation rule. This modification is intended to improve compatibility and increase the likelihood of successfully establishing a Co-TDMA agreement, thereby enabling AP1 to still benefit from sharing its TXOP under slightly adjusted fairness constraints. AP1 then sends a MAPC Negotiation Request frame containing the modified allocation rule to AP2. At operation 4a, AP2 parses the modified allocation rule and determines that the updated parameters are now compatible, at least to a minimum acceptable extent with AP2's own traffic and channel-access requirements. AP2 therefore returns a MAPC Negotiation Response frame containing an “accept” indication, signaling its willingness to participate in Co-TDMA under the modified terms.

### OPTION 2—Re-Negotiation Initiated by AP2

At operation 3b, if AP2 is unable to comply with the initially proposed allocation rule but can adjust some of its internal requirements within acceptable limits, AP2 may itself initiate the renegotiation by modifying one or more of its parameters so that a minimum match with AP1's declared allocation rule is achieved. AP2 then sends a baseline MAPC Negotiation Request frame containing the modified parameters back to AP1. At operation 4b, AP1 evaluates AP2's revised parameters and provides a MAPC Negotiation Response frame containing an “accept” indication, confirming that the modified agreement can be honored and that AP2 is now an eligible candidate AP.

FIG. 4D illustrates a message sequence chart using ICF for Polling phase according to an embodiment of the disclosure.

AP1 operates as the sharing Access Point (AP) that has obtained a Transmission Opportunity (TXOP) and seeks to share a portion of this TXOP with neighboring APs that are capable of participating in the Co-TDMA scheme. In this scenario, AP2 and AP3 constitute the neighboring APs that have expressed interest in participating and therefore form the set of candidate APs for coordinated operation. At operation 1, AP1, AP2, and AP3 exchange MAPC capability advertisement and discovery information, specifically including their respective support for the Co-TDMA scheme. This capability exchange enables the APs to determine which neighboring APs qualify for participation in the subsequent rule-based negotiation process.

At operation 2, basic negotiation and agreement occur between AP1-AP2 and AP1-AP3, during which both AP2 and AP3 communicate their willingness to participate in the Co-TDMA scheme with AP1. With the negotiation phase completed, the process transitions into the polling phase. At operation 3, AP1 initiates the polling operation by transmitting an Initial Control Frame (ICF) to all participating APs; the ICF includes the proposed allocation rule that defines the allowed traffic characteristics and channel-access characteristics applicable to the shared portion of the TXOP.

At operation 4, the participating APs—AP2 and AP3 parse the allocation rule carried within the ICF. Each AP examines whether its own traffic parameters and channel-access requirements are compatible with the criteria defined in AP1's allocation rule. At operations 5 and 6, AP2 and AP3 respectively determine that they each satisfy at least some of the rule criteria and therefore send an Initial Control Response (ICR) frame back to AP1 containing an “accept” indication. By doing so, AP2 and AP3 confirm their eligibility and readiness to utilize the shared portion of the TXOP under the constraints defined by the allocation rule.

Following these exchanges, the method continues into the TXOP allocation phase, during which AP1 performs the claimed AP-selection procedure to determine which one of the responding APs that is, AP2 or AP3 should receive the shared portion of the TXOP. AP1 then initiates dedicated signalling with the selected AP to complete the coordination process for shared TXOP usage.

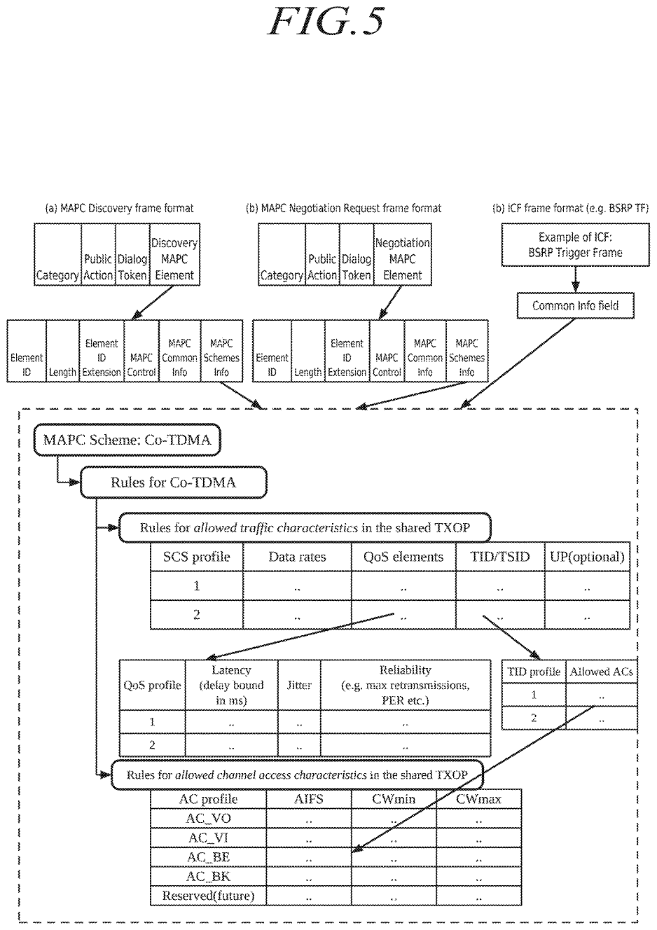

FIG. 5 illustrates a format of three messages according to an embodiment of the disclosure.

Referring to FIG. 5, the figure illustrates how the proposed allocation rule for the Co-TDMA scheme is incorporated into the three signalling messages used throughout the Co-TDMA operation, namely the MAPC Discovery frame, the MAPC Negotiation Request frame, and the Initial Control Frame (ICF) used during the polling phase. These examples demonstrate how the rule parameter set comprising allowed traffic characteristics and allowed channel-access characteristics is embedded within existing frame structures so that the sharing AP can transmit the allocation rules to neighboring APs.

In the case of the MAPC Discovery frame, the format shown corresponds to the latest MAPC standard draft. The device 200 utilizes the MAPC Schemes Info field, which is carried within the Discovery MAPC Element. When Co-TDMA is among the supported MAPC schemes, the MAPC Schemes Info field corresponding to the Co-TDMA identifier includes an additional sub-field that carries the proposed allocation rules for Co-TDMA. Through this mechanism, AP1 communicates the initial rule parameter set including the SCS profile, QoS profile, TID profile, and AC profile to neighboring APs during the capability advertisement and discovery phase.

For the MAPC Negotiation Request frame, the device 200 similarly reuses the MAPC Schemes Info field contained within the Negotiation MAPC Element. When AP1 transmits a negotiation request under Co-TDMA, the schemes Info field associated with the Co-TDMA scheme embeds the same proposed allocation rules. This allows AP1 to explicitly convey the allocation rules to a neighboring AP during negotiation, enabling that AP to determine whether its traffic- and channel-access characteristics comply with the parameters defined by AP1.

Finally, the device 200 adopts the Buffer Status Report Poll Trigger Frame (BSRP-TF) identified within the standards group as the most probable candidate as the ICF format. In this context, when Co-TDMA is supported, the Common Info field of the BSRP-TF includes an additional sub-field that carries the proposed allocation rules for Co-TDMA. Embedding the allocation rule within the ICF enables all participating APs to evaluate their compliance with the applicable rule parameters during the polling phase and to respond accordingly.

Through these examples, FIG. 5 demonstrates that the proposed allocation rule may be embedded consistently across all three key signaling frames used in the Co-TDMA scheme, which is Discovery, Negotiation Request, and ICF frames. This unified embedding mechanism ensures that the allocation rules are accessible at all stages of the Co-TDMA process, thereby enabling informed negotiation, dynamic re-negotiation when needed, and correct participation in the polling and TXOP-allocation phases.

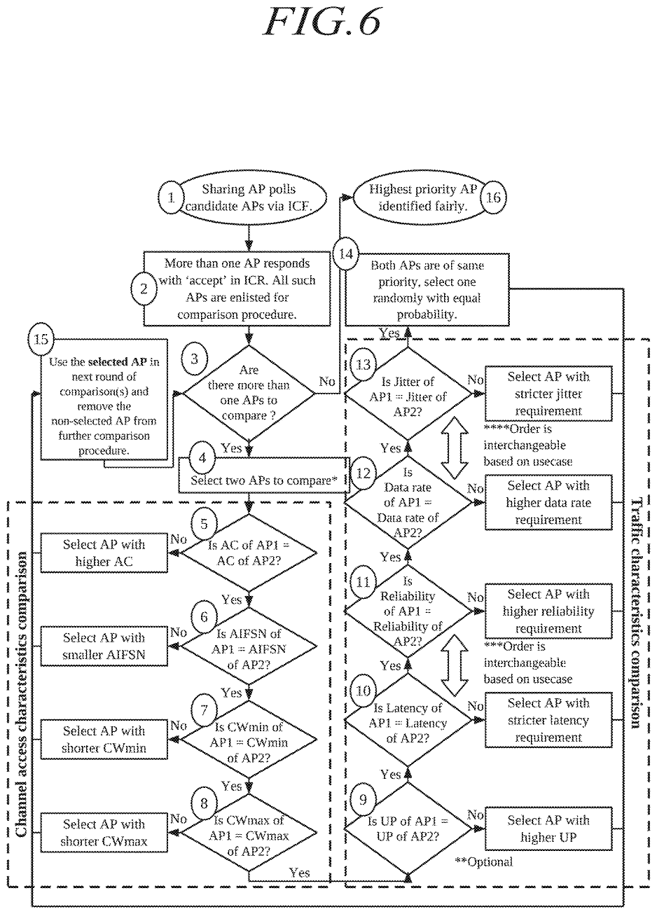

FIG. 6 illustrates a flowchart for selecting an optimal AP out of multiple responding APs according to an embodiment of the disclosure.

Referring to FIG. 6, the process illustrates the AP-selection procedure executed by the sharing AP after receiving multiple affirmative responses from neighboring APs during the polling phase. At operation 1, the sharing AP polls the candidate APs by transmitting an Initial Control Frame (ICF), requesting each AP to indicate its intent to utilize the shared portion of the TXOP. In operation 2, multiple APs may express their willingness to participate by returning an Initial Control Response (ICR) frame containing an “accept” indication, thereby establishing themselves as candidate APs eligible for further evaluation under the predefined selection procedure.

At operation 3, the sharing AP determines whether more than one candidate AP remains under consideration. If only a single AP remains, the process advances directly to operation 16 for final allocation; otherwise, the method proceeds to operation 4, where pairwise comparison is initiated. The sharing AP performs iterative pairwise comparisons using a predetermined ordering of channel-access and traffic-characteristic criteria to identify the most suitable AP.

At operation 5, if the Access Category (AC) values of the two APs being compared differ, the AP with the higher AC is immediately selected for advancement to the next comparison round, and the non-selected AP is eliminated; otherwise, if the AC values are equal, the method progresses to operation 6, where Arbitration Inter-Frame Space Number (AIFSN) values are compared. In operation 6, if the AIFSN values differ, the AP with the smaller AIFSN is selected; if equal, the process moves to operation 7 for comparison of minimum contention window (CWmin). In operation 7, the AP with the shorter CWmin is preferred unless both APs share the same value, in which case the method advances to operation 8, where maximum contention window (CWmax) values are compared, giving preference to the AP with the smaller CWmax.

If CWmax values are also identical, the procedure shifts to operation 9 for comparison of User Priority (UP), where the AP with the higher UP is selected. This operation may be optional and applied only when UP information is available. At operation 10, latency requirements are evaluated, with preference given to the AP with a stricter (i.e., lower) latency bound. At operation 11, reliability requirements are compared, selecting the AP with the higher reliability requirement; the order of operations 10 and 11 is interchangeable. At operation 12, the AP with the higher data-rate capability is favored; if both values are equal, the method continues to operation 13, where jitter requirements are assessed, selecting the AP with the stricter jitter constraint. The order of operations 12 and 13 is interchangeable.

If all parameters up to this point including AC, AIFSN, CWmin, CWmax, UP (when available), latency, reliability, data-rate capability, and jitter are identical, the comparison reaches operation 14, where both APs are deemed equivalent candidates. In such a case, the sharing AP selects one of the two APs at random with equal probability, ensuring unbiased resolution.

At operation 15, the AP selected from the pairwise comparison advances to the next round of comparisons, while the non-selected AP is removed from further consideration. The method then returns to operation 3 to determine whether additional comparisons are needed.

Finally, at operation 16, only one candidate AP remains after all pairwise comparisons and eliminations. This AP is identified as the best-suited AP to utilize the shared portion of the TXOP according to the predefined AP-selection procedure. The sharing AP thereafter performs the TXOP-allocation signaling exchange with the selected AP and proceeds to share the designated portion of the obtained TXOP with that AP, completing the selection and allocation process.

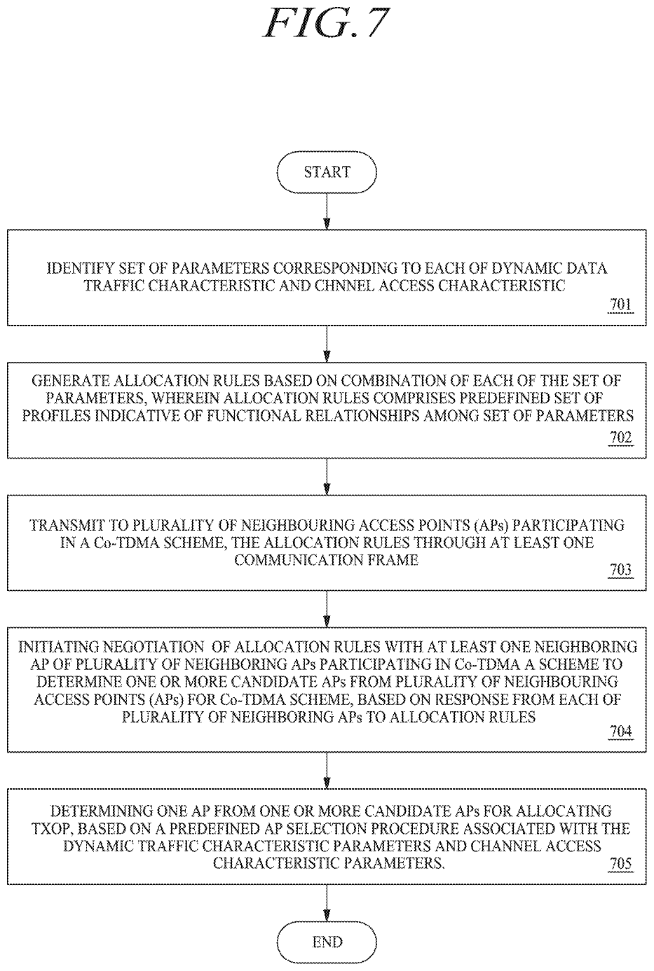

FIG. 7 shows a flowchart illustrating a method of allocating shared portion of Transmission Opportunity (TXOP) within a Coordinated Time Division Multiple Access (Co-TDMA) scheme according to an embodiment of the disclosure.

Referring to FIG. 7, a method 700 may be described in the general context of computer executable instructions. Generally, computer executable instructions can include routines, programs, objects, components, data structures, procedures, modules, and functions, which perform specific functions or implement specific abstract data types.

The order in which the method 700 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At block 701, the method 700 includes identifying a set of parameters corresponding to each of dynamic data traffic characteristic and channel access characteristic. The set of parameters corresponding to the data traffic characteristic at least comprises User Priority (UP), latency requirement, reliability requirement, data rate requirement, and Jitter requirement. In an embodiment, the set of parameters corresponding to the channel access characteristic at least comprises Access Category (AC), Arbitration Inter Frame Space Number (AIFSN), Contention Window Minimum (CWmin), and Contention Window Maximum (CWmax).

In an embodiment, the set of parameters comprises a first set of parameters and a second set of parameters. The first set of parameters relating to a plurality of traffic characteristics, and their ranges, for an allowed data transmission during the shared TXOP by a coordinated AP identified from the plurality of neighboring APs. The second set of parameters relates to a plurality of channel access characteristics, and their ranges, for sharing the TXOP by the coordinated AP. In an embodiment, the method includes classifying each of the set of parameters into the predefined set of profiles comprising Stream Classification Service (SCS) profile, Quality of Service (QoS) profile, Traffic Identifier (TID) profile and Access Category (AC) profile and identifying a mapping index between the set of profiles to define the functional relationships among a first and second set of parameters.

At block 702, the method 700 includes generating allocation rules based on a combination of each of the set of parameters. The allocation rules comprise a predefined set of profiles indicative of functional relationships among the set of parameters. Particularly, the set of parameters are combined for the generation of the allocation rules based on channel access and traffic characteristics, priority and profiling requirements associated with each parameter.

At block 703, the method 700 includes transmitting to a plurality of neighboring Access Points (APs) participating in a Co-TDMA scheme, the allocation rules through at least one communication frame. The at least one communication frame is selected from one of: a Multi-AP Coordination (MAPC) Discovery frame, a MAPC Negotiation Request frame, and an Initial Control Frame (ICF) of polling phase.

At block 704, the method 700 includes initiating a negotiation of the allocation rules with at least one neighboring AP of the plurality of neighboring APs participating in the Co-TDMA scheme to determine one or more candidate APs from the plurality of neighboring Access Points (APs) for the Co-TDMA scheme, based on a response from each of the plurality of neighboring APs to the allocation rules. In an embodiment, initiating the negotiation of the allocation rules comprise one of: receiving an acceptance response for the allocation rules by a neighboring AP and initiating a bi-directional negotiation with the at least one neighboring AP of the plurality of neighboring APs, when at least one of the plurality of neighboring APs is unable to comply with the allocation rules for sharing the TXOP. Herein, initiating the bi-directional negotiation comprises receiving responses from the at least one neighboring AP, and selectively adjusting the allocation rules based on feedback received during the negotiation, when the adjustments are acceptable to the AP.

At block 705, the method 700 includes determining one AP from the one or more candidate APs for allocating the TXOP, based on a predefined AP selection procedure associated with the dynamic traffic characteristic parameters and channel access characteristic parameters. In an embodiment, performing the AP selection procedure comprising performing iteratively a pairwise comparison of APs of the one or more candidate APs according to a predefined ordering of comparison criteria. The comparison criteria comprises a channel-access characteristics comparison in which, an AP having a higher access-category (AC), a smaller AIFSN, a shorter CWmin, and a shorter CWmax is selected and a traffic-characteristics comparison in which, an AP having a stricter latency requirement, a higher reliability requirement, a higher data-rate capability, and a stricter jitter requirement is selected. Further, the method includes selecting from the one or more candidate APs, the AP satisfying each of the channel-access and traffic-characteristic comparison criteria.

Thus, the disclosure provides several technical advantages over existing Co-TDMA based Multi-AP Coordination (MAPC) mechanisms. Conventional negotiation and polling procedures rely on limited parameters and lack a structured rule definition, resulting in inefficiencies, ambiguity, and unfair resource utilization. The proposed disclosure introduces a comprehensive rule-parameter set, a bidirectional negotiation mechanism, and a deterministic AP-selection procedure, all of which significantly enhance fairness, efficiency, and predictability in allocating the shared portion of the Transmission Opportunity (TXOP).

In an embodiment, the disclosure formalizes the exchange of traffic-related and channel-access-related parameters through a predefined allocation rule embedded consistently across MAPC Discovery, Negotiation Request, and Initial Control Frames. This ensures that all participating APs evaluate TXOP-sharing eligibility using uniform and clearly defined criteria rather than ad-hoc or incomplete information.

In an embodiment, the disclosure ensures that only a deserving and fully-qualified candidate AP, receives the shared portion of the TXOP. The AP-selection procedure performs stepwise, parameter-driven comparisons including AC, AIFSN, CWmin, CWmax, latency, reliability, data rate, and jitter to determine the optimal AP in a fair and transparent manner. This avoids scenarios in which an AP with inferior or incompatible characteristics gains access unfairly, thus improving overall channel utilization and quality-of-service outcomes.

In an embodiment, the disclosure offers flexibility in implementation, allowing the proposed allocation rule to be carried over multiple signalling options. The rule-parameter set may be transmitted through the MAPC Discovery frame during the capability-advertisement phase, the MAPC Negotiation Request frame during negotiation, or the Initial Control Frame during polling. This multi-frame compatibility ensures implementers can adopt the mechanism without disrupting existing signalling flows or introducing proprietary extensions.

Another notable advantage in the disclosure is that it offers for dynamic renegotiation, allowing APs to modify or adjust parameters when the initially proposed allocation rule is not acceptable. As a result, even APs that initially reject the proposed allocation rule can still engage in a subsequent negotiation round and benefit from participating in the Co-TDMA scheme if minimum acceptable conditions are met.

Collectively, these advantages result in a more efficient, fair, and adaptive shared-TXOP system, improving spectrum utilization, reducing contention, enhancing user experience, and enabling robust multi-AP coordination in next-generation WLAN deployments.

According to an embodiment, a method performed by a device for allocating shared portion of transmission opportunity (TXOP) within a coordinated time division multiple access (Co-TDMA) scheme, the method comprising: identifying, by the device, a set of parameters corresponding to each of dynamic data traffic characteristic and channel access characteristic; generating, by the device, allocation rules based on a combination of each of the set of parameters, the allocation rules comprising a predefined set of profiles indicative of functional relationships among the set of parameters; transmitting, by the device to a plurality of neighboring access points (APs) participating in a Co-TDMA scheme, the allocation rules through at least one communication frame; initiating, by the device, a negotiation of the allocation rules with at least one neighboring AP of the plurality of neighboring APs participating in the Co-TDMA scheme to determine one or more candidate APs from the plurality of neighboring APs for the Co-TDMA scheme, based on a response from each of the plurality of neighboring APs to the allocation rules; and determining, by the device, one AP from the one or more candidate APs for allocating the TXOP, based on a predefined AP selection procedure associated with the dynamic data traffic characteristic parameters and channel access characteristic parameters.

According to an embodiment, wherein the set of parameters corresponding to the dynamic data traffic characteristic at least comprises user priority (UP), latency requirement, reliability requirement, data rate requirement, and jitter requirement.

According to an embodiment, wherein the set of parameters corresponding to the channel access characteristic at least comprises access category (AC), arbitration inter frame space number (AIFSN), contention window minimum (CWmin), and contention window maximum (CWmax).

According to an embodiment, wherein the set of parameters are combined for the generation of the allocation rules based on channel access and traffic characteristics, priority and profiling requirements associated with each parameter.

According to an embodiment, wherein the at least one communication frame is selected from one of: a multi-AP coordination (MAPC) discovery frame; a MAPC negotiation request frame; or an initial control frame (ICF) of polling phase.

According to an embodiment, wherein the set of parameters comprises: a first set of parameters relating to a plurality of traffic characteristics, and their ranges, for an allowed data transmission during the shared TXOP by a coordinated AP identified from the plurality of neighboring APs; and a second set of parameters relating to a plurality of channel access characteristics, and their ranges, for sharing the TXOP by the coordinated AP.

According to an embodiment, wherein on identifying the set of parameters, the method further comprising: classifying each of the set of parameters into the predefined set of profiles comprising stream classification service (SCS) profile, quality of service (QoS) profile, traffic identifier (TID) profile and access category (AC) profile; and identifying a mapping index between the set of profiles to define the functional relationships among a first and second set of parameters.

According to an embodiment, wherein initiating the negotiation of the allocation rules comprise one of: receiving an acceptance response for the allocation rules by a neighboring AP; or initiating a bi-directional negotiation with the at least one neighboring AP of the plurality of neighboring APs, when at least one of the plurality of neighboring APs is unable to comply with the allocation rules for sharing the TXOP.

According to an embodiment, wherein initiating the bi-directional negotiation comprises: receiving responses from the at least one neighboring AP; and selectively adjusting the allocation rules based on feedback received during the negotiation, when the adjustments are acceptable to the AP.

According to an embodiment, wherein performing the AP selection procedure comprises: performing iteratively a pairwise comparison of APs of the one or more candidate APs according to a predefined ordering of comparison criteria, and wherein the comparison criteria comprises: a channel-access characteristics comparison in which, an AP having a higher access-category (AC), a smaller AIFSN, a shorter CWmin, and a shorter CWmax is selected, and a traffic-characteristics comparison in which, an AP having a stricter latency requirement, a higher reliability requirement, a higher data-rate capability, and a stricter jitter requirement is selected, and selecting, from the one or more candidate APs, the AP satisfying each of channel-access and traffic-characteristic comparison criteria.

According to an embodiment, a device for allocating shared portion of Transmission Opportunity (TXOP) within a coordinated time division multiple access (Co-TDMA) scheme, comprising: memory, comprising one or more storage media, storing instructions; and one or more processors communicatively coupled to the memory, wherein the instructions, when executed by the one or more processors individually or collectively, cause the device to: identify a set of parameters corresponding to each of dynamic data traffic characteristic and channel access characteristic, generate, allocation rules based on a combination of each of the set of parameters, the allocation rules comprising a predefined set of profiles indicative of functional relationships among the set of parameters, transmit to a plurality of neighboring Access Points (APs) participating in a Co-TDMA scheme, the allocation rules through at least one communication frame, initiate a negotiation of the allocation rules with at least one neighboring AP of the plurality of neighboring APs to determine one or more candidate APs from the plurality of neighboring APs for the Co-TDMA scheme, based on a response from each of the plurality of neighboring APs to the allocation rules, and determine one AP from the one or more candidate APs for allocating the TXOP, based on a predefined AP selection procedure associated with the dynamic data traffic characteristic parameters and channel access characteristic parameters.

According to an embodiment, wherein the set of parameters corresponding to the dynamic data traffic characteristic at least comprise user priority (UP), latency requirement, reliability requirement, data rate requirement, and jitter requirement.

According to an embodiment, wherein the set of parameters corresponding to the channel access characteristic at least comprises access category (AC), arbitration inter frame space number (AIFSN), contention window minimum (CWmin), and contention window maximum (CWmax).

According to an embodiment, wherein the instructions, when the executed by the one or more processors individually or collectively, further cause the device to combine the set of parameters for the generation of the allocation rules based on channel access and traffic characteristics, priority and profiling requirements associated with each parameter.

According to an embodiment, wherein the instructions, when the executed by the one or more processors individually or collectively, further cause the device to select at least one communication frame from one of: a multi-AP coordination (MAPC) discovery frame, a MAPC negotiation request frame, or an initial control frame (ICF) of polling phase.

According to an embodiment, wherein the set of parameters comprises: a first set of parameters relating to a plurality of traffic characteristics, and their ranges, for an allowed data transmission during the shared TXOP by a coordinated AP identified from the plurality of neighboring APs; and a second set of parameters relating to a plurality of channel access characteristics, and their ranges, for sharing the TXOP by the coordinated AP.

According to an embodiment, wherein the instructions, when executed by the one or more processors individually or collectively, further cause the device to: in response to identifying the set of parameters: classify each of the set of parameters into the predefined set of profiles, wherein the predefined set of profiles comprises stream classification service (SCS) profile, quality of service (QoS) profile, traffic identifier (TID) profile and access category (AC) profile; and identify a mapping index between the set of profiles to define the functional relationships among a first and second set of parameters.

According to an embodiment, wherein for initiating the negotiation of the allocation rules, the instructions, when executed by the one or more processors individually or collectively, further cause the device to: receive an acceptance response for the allocation rules by a neighboring AP; and initiate a bi-directional negotiation with the at least one neighboring AP of the plurality of neighboring APs, when at least one of the plurality of neighboring APs is unable to comply with the allocation rules for sharing the TXOP.

According to an embodiment, wherein for initiating the bi-directional negotiation, the instructions, when executed by the one or more processors individually or collectively, further cause the device to: receive responses from the at least one neighboring AP; and selectively adjust the allocation rules based on feedback received during the negotiation, when the adjustments are acceptable to the AP.

According to an embodiment, wherein for performing the AP selection procedure, the instructions, when executed by the one or more processors individually or collectively, further cause the device to: perform iteratively a pairwise comparison of APs of the one or more candidate APs according to a predefined ordering of comparison criteria, and wherein the comparison criteria comprises: a channel-access characteristics comparison in which, an AP having a higher access-category (AC), a smaller AIFSN, a shorter CWmin, and a shorter CWmax is selected, and a traffic-characteristics comparison in which, an AP having a stricter latency requirement, a higher reliability requirement, a higher data-rate capability, and a stricter jitter requirement is selected, and select, from the one or more candidate APs, the AP satisfying each of channel-access and traffic-characteristic comparison criteria.

According to an embodiment, wherein, when the AC, the smaller AIFSN, the shorter CWmin, the short CWmax, the strict latency requirement, the higher reliability requirement, the higher data-rate capability, and the stricter jitter requirement are identical, the pairwise compared APs are deemed equivalent candidates.

According to an embodiment, wherein, when the pairwise compared APs are deemed equivalent candidates, the instructions, when executed by the one or more processors individually or collectively, further cause the device to randomly choose one of the pairwise compared APs.

According to an embodiment, one or more non-transitory computer-readable storage media storing one or more computer programs including computer-executable instructions that, when executed by one or more processors of an device for allocating shared portion of transmission opportunity (TXOP) within a coordinated time division multiple access (Co-TDMA) scheme, individually or collectively, cause the device to perform operations, the operations comprising: identifying a set of parameters corresponding to each of dynamic data traffic characteristic and channel access characteristic; generating, allocation rules based on a combination of each of the set of parameters, the allocation rules comprising a predefined set of profiles indicative of functional relationships among the set of parameters; transmitting, to a plurality of neighboring access points (APs) participating in a Co-TDMA scheme, the allocation rules through at least one communication frame; initiating a negotiation of the allocation rules with at least one neighboring AP of the plurality of neighboring APs participating in the Co-TDMA scheme to determine one or more candidate APs from the plurality of neighboring APs for the Co-TDMA scheme, based on a response from each of the plurality of neighboring APs to the allocation rules; and determining one AP from the one or more candidate APs for allocating the TXOP, based on a predefined AP selection procedure associated with the dynamic data traffic characteristic parameters and channel access characteristic parameters.

According to an embodiment, wherein the set of parameters corresponding to the dynamic data traffic characteristic at least comprises user priority (UP), latency requirement, reliability requirement, data rate requirement, and jitter requirement.

According to an embodiment, a method performed by a coordinated access point (AP) for participating in a coordinated time division multiple access (Co-TDMA) scheme, the method comprising: receiving, by the coordinated AP from a sharing AP through at least one communication frame, allocation rules based on a combination of a set of parameters corresponding to each of dynamic data traffic characteristic and channel access characteristic, the allocation rules comprising a predefined set of profiles indicative of functional relationships among the set of parameters; and transmitting, by the coordinated AP to the sharing AP, a response to the allocation rules indicating acceptance or rejection of participation in the Co-TDMA scheme.

In light of the technical advancements provided by the disclosed method, the claimed operations, as discussed above, are not routine, conventional, or well-known aspects in the art, as the claimed operations provide the aforesaid solutions to the technical problems existing in the conventional technologies. Further, the claimed operations clearly bring an improvement in the functioning of the system itself, as the claimed operations provide a technical solution to a technical problem.

The terms “an embodiment”, “embodiment”, “embodiments”, “the embodiment”, “the embodiments”, “one or more embodiments”, “some embodiments”, and “one embodiment” mean “one or more (but not all) embodiments of the disclosure (s)” unless expressly specified otherwise.

The terms “including”, “comprising”, “having” and variations thereof mean “including but not limited to”, unless expressly specified otherwise.

The enumerated listing of items does not imply that any or all the items are mutually exclusive, unless expressly specified otherwise. The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the disclosure.

When a single device or article is described herein, it will be clear that more than one device/article (whether they cooperate) may be used in place of a single device/article. Similarly, where more than one device/article is described herein (whether they cooperate), it will be clear that a single device/article may be used in place of the more than one device/article or a different number of devices/articles may be used instead of the shown number of devices or programs. The functionality and/or features of a device may be alternatively embodied by one or more other devices which are not explicitly described as having such functionality/features. Thus, other embodiments of disclosure need not include the device itself.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based here on. Accordingly, the embodiments of the disclosure are intended to be illustrative, but not limiting, of the scope of the disclosure, which is set forth in the following claims.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a device for allocating shared portion of transmission opportunity (TXOP) within a coordinated time division multiple access (Co-TDMA) scheme, the method comprising:
identifying, by the device, a set of parameters corresponding to each of dynamic data traffic characteristic and channel access characteristic;
generating, by the device, allocation rules based on a combination of each of the set of parameters, the allocation rules comprising a predefined set of profiles indicative of functional relationships among the set of parameters;
transmitting, by the device to a plurality of neighboring access points (APs) participating in a Co-TDMA scheme, the allocation rules through at least one communication frame;
initiating, by the device, a negotiation of the allocation rules with at least one neighboring AP of the plurality of neighboring APs participating in the Co-TDMA scheme to determine one or more candidate APs from the plurality of neighboring APs for the Co-TDMA scheme, based on a response from each of the plurality of neighboring APs to the allocation rules; and
determining, by the device, one AP from the one or more candidate APs for allocating the TXOP, based on a predefined AP selection procedure associated with the dynamic data traffic characteristic parameters and channel access characteristic parameters.

2. The method as claimed in claim 1, wherein the set of parameters corresponding to the dynamic data traffic characteristic at least comprises user priority (UP), latency requirement, reliability requirement, data rate requirement, and jitter requirement.

3. The method as claimed in claim 1, wherein the set of parameters corresponding to the channel access characteristic at least comprises access category (AC), arbitration inter frame space number (AIFSN), contention window minimum (CWmin), and contention window maximum (CWmax).

4. The method as claimed in claim 1, wherein the set of parameters are combined for the generation of the allocation rules based on channel access and traffic characteristics, priority and profiling requirements associated with each parameter.

5. The method as claimed in claim 1, wherein the at least one communication frame is selected from one of:
a multi-AP coordination (MAPC) discovery frame;
a MAPC negotiation request frame; or
an initial control frame (ICF) of polling phase.

6. The method as claimed in claim 1, wherein the set of parameters comprises:
a first set of parameters relating to a plurality of traffic characteristics, and their ranges, for an allowed data transmission during the shared TXOP by a coordinated AP identified from the plurality of neighboring APs; and
a second set of parameters relating to a plurality of channel access characteristics, and their ranges, for sharing the TXOP by the coordinated AP.

7. The method as claimed in claim 1, wherein on identifying the set of parameters, the method further comprising:
classifying each of the set of parameters into the predefined set of profiles comprising stream classification service (SCS) profile, quality of service (QoS) profile, traffic identifier (TID) profile and access category (AC) profile; and
identifying a mapping index between the set of profiles to define the functional relationships among a first and second set of parameters.

8. The method as claimed in claim 1, wherein initiating the negotiation of the allocation rules comprise one of:
receiving an acceptance response for the allocation rules by a neighboring AP; or
initiating a bi-directional negotiation with the at least one neighboring AP of the plurality of neighboring APs, when at least one of the plurality of neighboring APs is unable to comply with the allocation rules for sharing the TXOP.

9. The method as claimed in claim 8, wherein initiating the bi-directional negotiation comprises:
receiving responses from the at least one neighboring AP; and
selectively adjusting the allocation rules based on feedback received during the negotiation, when the adjustments are acceptable to the AP.

10. The method as claimed in claim 1,
wherein performing the AP selection procedure comprises:
performing iteratively a pairwise comparison of APs of the one or more candidate APs according to a predefined ordering of comparison criteria, and
wherein the comparison criteria comprises:
a channel-access characteristics comparison in which, an AP having a higher access-category (AC), a smaller AIFSN, a shorter CWmin, and a shorter CWmax is selected, and
a traffic-characteristics comparison in which, an AP having a stricter latency requirement, a higher reliability requirement, a higher data-rate capability, and a stricter jitter requirement is selected, and
selecting, from the one or more candidate APs, the AP satisfying each of channel-access and traffic-characteristic comparison criteria.

11. A device for allocating shared portion of Transmission Opportunity (TXOP) within a coordinated time division multiple access (Co-TDMA) scheme, comprising:
memory, comprising one or more storage media, storing instructions; and
one or more processors communicatively coupled to the memory,
wherein the instructions, when executed by the one or more processors individually or collectively, cause the device to:
identify a set of parameters corresponding to each of dynamic data traffic characteristic and channel access characteristic,
generate, allocation rules based on a combination of each of the set of parameters, the allocation rules comprising a predefined set of profiles indicative of functional relationships among the set of parameters,
transmit to a plurality of neighboring Access Points (APs) participating in a Co-TDMA scheme, the allocation rules through at least one communication frame,
initiate a negotiation of the allocation rules with at least one neighboring AP of the plurality of neighboring APs to determine one or more candidate APs from the plurality of neighboring APs for the Co-TDMA scheme, based on a response from each of the plurality of neighboring APs to the allocation rules, and
determine one AP from the one or more candidate APs for allocating the TXOP, based on a predefined AP selection procedure associated with the dynamic data traffic characteristic parameters and channel access characteristic parameters.

12. The device as claimed in claim 11, wherein the set of parameters corresponding to the dynamic data traffic characteristic at least comprise user priority (UP), latency requirement, reliability requirement, data rate requirement, and jitter requirement.

13. The device as claimed in claim 11, wherein the set of parameters corresponding to the channel access characteristic at least comprises access category (AC), arbitration inter frame space number (AIFSN), contention window minimum (CWmin), and contention window maximum (CWmax).

14. The device as claimed in claim 11, wherein the instructions, when the executed by the one or more processors individually or collectively, further cause the device to combine the set of parameters for the generation of the allocation rules based on channel access and traffic characteristics, priority and profiling requirements associated with each parameter.

15. The device as claimed in claim 11, wherein the instructions, when the executed by the one or more processors individually or collectively, further cause the device to select at least one communication frame from one of:
a multi-AP coordination (MAPC) discovery frame,
a MAPC negotiation request frame, or
an initial control frame (ICF) of polling phase.

16. The device as claimed in claim 11, wherein the set of parameters comprises:
a first set of parameters relating to a plurality of traffic characteristics, and their ranges, for an allowed data transmission during the shared TXOP by a coordinated AP identified from the plurality of neighboring APs; and
a second set of parameters relating to a plurality of channel access characteristics, and their ranges, for sharing the TXOP by the coordinated AP.

17. The device as claimed in claim 11, wherein the instructions, when executed by the one or more processors individually or collectively, further cause the device to:
in response to identifying the set of parameters:
classify each of the set of parameters into the predefined set of profiles, wherein the predefined set of profiles comprises stream classification service (SCS) profile, quality of service (QoS) profile, traffic identifier (TID) profile and access category (AC) profile; and
identify a mapping index between the set of profiles to define the functional relationships among a first and second set of parameters.

18. The device as claimed in claim 11, wherein for initiating the negotiation of the allocation rules, the instructions, when executed by the one or more processors individually or collectively, further cause the device to:
receive an acceptance response for the allocation rules by a neighboring AP; and
initiate a bi-directional negotiation with the at least one neighboring AP of the plurality of neighboring APs, when at least one of the plurality of neighboring APs is unable to comply with the allocation rules for sharing the TXOP.

19. The device as claimed in claim 18, wherein for initiating the bi-directional negotiation, the instructions, when executed by the one or more processors individually or collectively, further cause the device to:
receive responses from the at least one neighboring AP; and
selectively adjust the allocation rules based on feedback received during the negotiation, when the adjustments are acceptable to the AP.

20. The device as claimed in claim 11,
wherein for performing the AP selection procedure, the instructions, when executed by the one or more processors individually or collectively, further cause the device to:
perform iteratively a pairwise comparison of APs of the one or more candidate APs according to a predefined ordering of comparison criteria, and
wherein the comparison criteria comprises:
a channel-access characteristics comparison in which, an AP having a higher access-category (AC), a smaller AIFSN, a shorter CWmin, and a shorter CWmax is selected, and
a traffic-characteristics comparison in which, an AP having a stricter latency requirement, a higher reliability requirement, a higher data-rate capability, and a stricter jitter requirement is selected, and
select, from the one or more candidate APs, the AP satisfying each of channel-access and traffic-characteristic comparison criteria.

21. The device as claimed in claim 20, wherein, when the AC, the smaller AIFSN, the shorter CWmin, the short CWmax, the strict latency requirement, the higher reliability requirement, the higher data-rate capability, and the stricter jitter requirement are identical, the pairwise compared APs are deemed equivalent candidates.

22. The device as claimed in claim 21, wherein, when the pairwise compared APs are deemed equivalent candidates, the instructions, when executed by the one or more processors individually or collectively, further cause the device to randomly choose one of the pairwise compared APs.

23. One or more non-transitory computer-readable storage media storing one or more computer programs including computer-executable instructions that, when executed by one or more processors of an device for allocating shared portion of transmission opportunity (TXOP) within a coordinated time division multiple access (Co-TDMA) scheme, individually or collectively, cause the device to perform operations, the operations comprising:
identifying a set of parameters corresponding to each of dynamic data traffic characteristic and channel access characteristic;
generating, allocation rules based on a combination of each of the set of parameters, the allocation rules comprising a predefined set of profiles indicative of functional relationships among the set of parameters;
transmitting, to a plurality of neighboring access points (APs) participating in a Co-TDMA scheme, the allocation rules through at least one communication frame;
initiating a negotiation of the allocation rules with at least one neighboring AP of the plurality of neighboring APs participating in the Co-TDMA scheme to determine one or more candidate APs from the plurality of neighboring APs for the Co-TDMA scheme, based on a response from each of the plurality of neighboring APs to the allocation rules; and
determining one AP from the one or more candidate APs for allocating the TXOP, based on a predefined AP selection procedure associated with the dynamic data traffic characteristic parameters and channel access characteristic parameters.

24. The one or more non-transitory computer-readable storage media of claim 23, wherein the set of parameters corresponding to the dynamic data traffic characteristic at least comprises user priority (UP), latency requirement, reliability requirement, data rate requirement, and jitter requirement.
